(19) United States
(12) Patent Application Publication
(10) Pub. No.: US 2016/0224319 A1
(43) Pub. Date: Aug. 4, 2016

(54) HIGH-SPEED THREE-OPERAND N-BIT ADDER

(71) Applicants: Huong HO, Woodlawn (CA); Michel Kafrouni, Ottawa (CA)

(72) Inventors: Huong HO, Woodlawn (CA); Michel Kafrouni, Ottawa (CA)

(21) Appl. No.: 14/610,739

(22) Filed: Jan. 30, 2015

(51) Int. Cl. G06F 7/509

(52) U.S. Cl. CPC G06F 7/509

(57) ABSTRACT

An adder and a method for calculating a sum of three input operands. The adder comprises a pre-processor, a generator and a post-processor. The pre-processor creates an initial propagation vector having a plurality of bit-positions, each bit-position in the plurality representing whether a carry in bit is propagated as a carry out bit as determined from a value of respective bit-positions of each of the three operands. The pre-processor creates an initial generation vector having a plurality of bit-positions, each bit-position in the plurality representing whether a carry out bit is generated as determined from a value of respective bit-positions of each of the three operands. The generator generates a composite propagation vector and a composite generation vector from parallel prefix operations on the initial propagation vector and initial generation vector. The post-processor calculates the sum from the initial propagation vector, the composite propagation vector and the composite generation vector. The adder has a gate delay of 2 log₂(N)+4.

### RELATED APPLICATIONS

Not Applicable.

### TECHNICAL FIELD

The present disclosure relates to digital circuits and in particular to N-bit adders.

### BACKGROUND

Modern digital signal processor (DSP) and Central Processing Unit (CPU) circuits designed for wireless application are often called upon to perform high-speed multiplication of multiple N-bit operands. Such multiplication operations typically involve the parallel and simultaneous calculation of N partial products and the summing or accumulation of these N-partial products to generate the product of the multiplication. Accordingly, the speed and efficiency with which these multiplication operations can be achieved is dependent in part on the speed and efficiency with which the addition of multiple N-bit operands can be achieved.

In some cases, the N partial products generated in a multiplication of two N-bit operands will be summed using 3:2 Carry Save Adders (CSAs). Each CSA takes three N-bit operands as inputs and adds them together to generate two N-bit outputs. Thus, the N partial products can be combined in a number of levels of parallel CSAs until a level is reached, in which only one CSA is used, generating two N+1-bit outputs. A two-operand N+1-bit adder may then add the two outputs of this CSA to generate a single N+2-bit sum that represents the product of the multiplication operation.

FIG. 1 shows an example configuration of four levels of CSAs to add seven N-bit operands 1-7, to compress groups of three operands each into two groups of outputs in multiple levels, until a final CSA occupying its own level generates the final two outputs 22, 23 for addition by a two-operand N+1-bit adder 24 to calculate an N+2-bit result 25.

The first level comprises two CSAs 9, 10. CSA 9 accepts as operands three N-bit numbers 1-3 and generates two N-bit outputs 11, 12. CSA 10 accepts as operands three N-bit numbers 4-6 and generates two N-bit outputs 13, 14. The second level comprises CSA 15 that accepts as operands three N-bit outputs 11-13 and generates two N-bit outputs 16, 17. The third level comprises CSA 18 that accepts as operands three N-bit outputs 14, 17 and N-bit number 7 and generates two N-bit outputs 19, 20. The fourth level comprises CSA 21 that accepts as operands three N-bit outputs 16, 19, 20 and generates two N+1-bit outputs 22, 23. The outputs are shown as N+1-bit because as will be discussed later, one of the outputs 22 is shifted left (multiplied by 2) prior to being input into an adder 24.

The two N+1-bit outputs 22, 23 are input into a two-operand N+1-bit adder 24, which generates an N+2-bit output 25. This output 25 represents the sum of all of the operands 1-7.

FIG. 2A is a truth table showing the results of binary addition of three one-bit operands a, b and c. There are two outputs, namely a caRry bit r and a Sum bit s. If the carry bit r and the sum bit s were treated as the most significant bit (MSB) and the least significant bit (LSB) of a two-bit result, it can be seen that the addition of the three operands produces the result represented by the two-bit combination.

Consideration of the truth table of FIG. 2A and each of the carry and sum outputs individually yields the following relationships:

Sum s=a ⊕ b ⊕ c, (1)

Carry r=a*b+a*c+b*c, (2)

where + denotes a logical OR operation;
* denotes a logical AND operation; and
⊕ denotes an exclusive-OR operation.

The implementation of the truth table of FIG. 2A as a CSA 30 is shown in FIG. 2B. The three operands are a 31, b 32 and c 33 while the two outputs are the carry r 34 and sum s 35 outputs. In the case of the truth table of FIG. 2A, the operands and the outputs are each one bit in length.

FIG. 3A shows an example digital logic circuit that implements the one-bit CSA of FIG. 2B. The circuit, shown generally at 30, comprises an XOR gate 36, three AND gates 37-39 and an OR gate 40. Operands a 31, b 32 and c 33 are inputs to XOR gate 36, resulting in the sum output s 35. Operands a 31 and b 32 are inputs to AND gate 37, resulting in an output 41. Operands a 31 and c 33 are inputs to AND gate 38, resulting in an output 42. Operands b 32 and c 33 are inputs to AND gate 39, resulting in an output 43. Outputs 41-43 are inputs to OR gate 40, resulting in the carry output r 34.

The relationship between Equations (1) and (2) can be used to develop relationships that permit the development of an N-bit 3:2 CSA. Each of the N bits may be considered as a separate one-bit stream that is processed in bit-wise fashion.

In this disclosure, an upper-case letter denotes a multiple-bit bit stream and a lower-case letter denotes a single bit. In general, a bit-position may be denoted by subscript i or surrounded in parentheses (i), signifying that such bit-position may be any one from 0 to N−1 (0 . . . N−1). For ease of description and in accordance with convention, in this disclosure, the LSB is shown as appearing as the right-most bit-position and the MSB is shown as appearing as the left-most bit-position. Further, following such convention, reference may be made to a bit-position that is immediately to the right of a bit-position (i) as bit-position (i−1) or as a previous significant bit-position (PSB) and to a bit-position that is immediately to the left of a bit-position (i) as bit-position (i+1) or as a next significant bit-position (NSB).

Further, for ease of description and in accordance with convention, when referring to the entire N-bit entity, the entity, for example Q, may be denoted as a vector Q[0 . . . N−1]. Further, a subset of bit-positions of an entity may be denoted by showing the operative subset of bit-positions, for example, Q[2 . . . N−2].

Thus, the addition of the LSB, designated bit-position (0), may be accomplished by a digital circuit equivalent to that of FIG. 3A, such as FIG. 3B. FIG. 3B shows a logical equivalent digital circuit, shown generally at 45, corresponding to bit-position (0) of the N-bit bit stream. The bit-position (0) operands are designated a₀, b₀ and c₀ respectively. The corresponding sum and carry bit outputs are designated s₀ and r₀ respectively.

In FIG. 3B, circuit 45 comprises two XOR gates 49, 51, two AND gates 53, 55 and an OR gate 57. Operands a₀ 46 and b₀ 47 are inputs to XOR gate 49, resulting in an output 50. Operand c₀ 48 and output 50 are inputs to XOR gate 51, resulting in a sum bit s₀ 52. Operands a₀ 46, b₀ 47 are inputs to AND gate 53, resulting in an output 54. Operands c₀ 48 and output 50 are inputs to AND gate 55, resulting in an output 56. Outputs 54, 56 are inputs to OR gate 57, resulting in carry bit r₀ 58.

The throughput of a circuit is conventionally roughly approximated in terms of AND/OR gate delays. The gate delay is notionally the number of levels of two-input AND and/or OR gates employed to implement the circuit. Further, the generation of inverted signals, which can be obtained by negating the gate output, is not counted as a separate gate level, even if implemented by a discrete inverter. Further, an XOR gate, which can be represented as an OR of pairwise combinations of inputs, one of which is not inverted and the other(s) of which are inverted, is considered to incur two levels of AND/OR gates and thus imposes a gate delay of two.

It can be thus seen that FIG. 3B incurs four gate delays to generate the sum and carry bit outputs from the input operands.

In FIG. 3C, which is functionally identical to the example of FIG. 3B, circuit 45 accepts as operands, the bit-position 1 inputs designated a₁ 59, b₁ 60, c₁ 61 and generates corresponding sum bit s₁ 62 and carry bit r₁ 63.

Conceptually, it has been shown that an N-bit 3:2 CSA may be generated by treating the N bits of each of three operands as N one-bit data streams and processing the three operands on a bit-wise basis. The resultant N sum bits sᵢ could then be reconstituted as an N-bit result or vector S[0 . . . N−1] and the N carry bits rᵢ could then be reconstituted as an N-bit result or vector R[0 . . . N−1], incurring a gate delay of 4.

Further, it has been shown by Von Neumann that a partial sum result PS[0 . . . N−1] and R[0 . . . N−1] can be combined by an additive operation to generate an N+1-bit sum of the three N-bit operands, provided that R[0 . . . N] is left-shifted (effectively multiplied by 2) to generate a “Carry Shift” result CS[0 . . . N] (where the LSB is padded with a “0”) prior to its addition to PS[0 . . . N] (where the MSB bit-position (N) is padded with the value of the NSB bit-position (N−1)). An example of such addition is shown in FIG. 4A. As was shown in connection with FIG. 3B, the bit-wise addition operation has a gate delay of 4. Thus, the N-bit CSA has a total gate delay of 4.

One example way of implementing this is shown in the schematic of FIG. 4B in which the csᵢ output of a less significant CSA is added to the psᵢ₊₁ output of the next most significant CSA in a corresponding one of N daisy-chained two-input adders.

It will be appreciated from a consideration of FIG. 5, that a 3:2 CSA 30 could be reconfigured as a two-operand one-bit ripple carry adder 65 having a carry-in bit rᵢ₋₁ 66 and a carry-out bit rᵢ 67 in place of operand c 33 and carry bit r 34 respectively. Conceivably, N+1 of such adders 65 could be daisy-chained so that the carry-out bit rᵢ67 corresponding to a PSB adder 65 could be fed in as the carry-in bit rᵢ₋₁ 66 of the NSB adder 65. However, in doing so, significant delays would be encountered in propagating carry bits from the LSB to the MSB, especially as N grows larger. Indeed, it can be shown that such an implementation would incur on the order of 2N gate delays.

In some cases, as discussed above, the two-operand N+1-bit adder 24 shown below the fourth level of CSA 21 in FIG. 1 could comprise a daisy-chain of N+1 two-operand one-bit adders 65, with attendant ripple delays.

To avoid such ripple propagation delays, carry generation (G) and propagation (P) relationships have been developed. Turning now to FIG. 6A, there is shown a truth table showing two one-bit input operands aᵢ 74 and bᵢ 75 and output carry-out bit rᵢ 67 as a function of the carry-in bit rᵢ₋₁.

As can be seen, from rows 71, 72, if the operands aᵢ 74 and bᵢ 75 are different, the carry-out bit rᵢ 67 is the same as the carry-in bit rᵢ₋₁. That is, in such a case, the carry-out or carry bit rᵢ 67 is said to propagate the carry-in bit rᵢ₋₁, leading to the relationship:

pᵢ=aᵢ ⊕ bᵢ, (3)

where p indicates that rᵢ=rᵢ₋₁ and

i indicates.the i^{th} bit-position in the N-bit stream.

Further, as can be seen, from row 73, if the operands aᵢ 74 and bᵢ 75 are both “1”, the carry bit rᵢ 67 is also “1”. That is, in such a case, the carry bit rᵢ 67 is said to generate a carry, leading to the relationship:

gᵢ=aᵢ*bᵢ, (4)

where g indicates that rₒᵤₜ=“1” irrespective of the input operand values.

Thus, rᵢ=gᵢ+pᵢ*rᵢ₋₁ (5)

From Equation (5), we arrive at:

r₀=g₀+p₀*rᵢₙ, (6)

r₁=g₁+p₁*g₀+(p₁*p₀*rᵢₙ), (7)

r₂=g₂+p₂*g₁+p₂*p₁*g₀+p₂*p₁*p₀*rᵢₙ, (8)

and so on.

Similarly, from Equations (1) (using 2-operand math) and (3), we arrive at:

sᵢ=pᵢ ⊕ rᵢ. (9)

In Kogge, P. & Stone, H. “A Parallel Algorithm for the Efficient Solution of a General Class of Recurrence Equations”, IEEE Transactions on Computers, 1973, c-22, pp. 783-791, it is shown that composite values of p and g can be calculated from two previous values of p and g and used in place of the previous values of p and g, including in calculating further composite values.

The Kogge-Stone (“KS”) architecture consists of log₂(N)+1 rows of composite propagation vectors Pⱼ[0 . . . N−1], each consisting of N (composite) propagation variables p_{j,i}, i=0 . . . N−1 and corresponding log₂(N)+1 rows of composite generation vectors Gⱼ[0 . . . N−1], each consisting of N (composite) generation variables g_{j,i}, where i=0 . . . N−1, and j=0 . . . M−1, where M=log₂(N)+1. Accordingly, the KS architecture may be considered to comprise an log₂ N×N array of propagation and generation variable pairs (p_{j,i}, g_{j,i}). These pairs are calculated row by row. The pairs in a given row can be calculated simultaneously. Thus, the calculation of the pairs in successive rows is denoted as a parallel prefix operation.

For the first (0^{th}) row j=0:

p_{0,i}=aᵢ ⊕ bᵢ, (10)

g_{0,i}=aᵢ*bᵢ. (11)

It will be appreciated from FIG. 1, that if the KS adder implements adder 24, aᵢ could be the carry bit rᵢ of the fourth level of CSA 21 and bᵢ could be the sum bit sᵢ of the CSA 21, leading to:

p_{0,i}=rᵢ ⊕ sᵢ, (12)

g_{0,i}=rᵢ*sᵢ. (13)

FIG. 6B shows an example digital logic circuit that implements the relationships of Equations (12) and (13). The circuit, shown generally at 80, comprises an XOR gate 81 and an AND gate 85, accepts carry bit rᵢ 67 and sum bit sᵢ 35 as inputs and outputs initial propagation variable p_{0,i} 84 and initial generation variable g_{0,i} 86. Carry bit rᵢ 67 and sum bit sᵢ 35 are inputs to XOR gate 81, resulting in initial propagation variable p_{0,i} 84. Carry bit rᵢ 67 and sum bit sᵢ 35 are inputs to AND gate 85, resulting in initial generation variable g_{0,i} 86.

Thus, the calculation of this row of initial propagation and generation variables incurs two gate delays (recognizing again that an XOR operation is equivalent to two two-input AND/OR gate delays).

For subsequent rows j=1 . . . log₂(N) and for columns (vector entries) i=0 . . . 2^{j-1}−1:

p_{j,i}=0, (14)

g_{j,i}=gⱼ₋₁,ᵢ. (15)

For rows j=1 . . . log₂(N) and for columns i=2^{j-1} . . . N−1:

p_{j,i}=pⱼ₋₁,ᵢ*pⱼ₋₁,ᵢ₋ₖ, (16)

g_{j,i}=pⱼ₋₁,ᵢ*gⱼ₋₁,ᵢ₋ₖ+gⱼ₋₁,ᵢ, (17)

where k=2^{j-1}.

FIG. 6C shows an example digital logic circuit that implements the relationships of Equations (16) and (17). The circuit, shown generally at 87, comprises two AND gates 88, 94 and an OR gate 96, accepts propagation variables p_{j-1,i-k} 89, p_{j-1,i} 92, generation variables g_{j-1,i-k} 90 and g_{j-1,i} 93 as inputs and outputs composite propagation variable p_{j,i} 91 and composite generation variable g_{j.i} 97. Propagation variables p_{j-1,i-k} 89 and p_{j-1,i} 92 are inputs to AND gate 88, resulting in composite propagation variable p_{j,i} 91. Generation variable g_{j-1,i-k} 90 and propagation variable p_{j-1,i} 92 are inputs to AND gate 94, resulting in output 95. Generation variable g_{j-1,i} 93 and output 95 are inputs to OR gate 96, resulting in composite generation variable output g_{j,i} 97.

FIG. 6D shows a schematic representation of circuit 87, showing its inputs propagation variable p_{j-1,i-k} 89, generation variable g_{j-1,i-k} 90, propagation variable p_{j-1,i} 92, generation variable g_{j-1,i} 93 and outputs composite propagation variable p_{j,i} 91 and composite generation variable g_{j,i} 97.

FIG. 7 shows a schematic representation of a prefix portion of a two-operand 8-bit KS adder with sparsity 1. The numbers shown in the diamonds in rows j=1 . . . 3 represent the values of i for p_{0,i} and g_{0,i} from row j=0 that are covered by a given prefix operation. It can be seen that the left-most diamond in row j=3 covers all values of p_{0,i} and g_{0,i}, demonstrating the power of the parallel prefix operation.

As can be seen, the prefix-generating portion of the two-operand 8-bit KS adder has three levels or generally, for an N-bit word length, 2 log₂(N) levels. From FIG. 6C, it may be seen that each of these levels incurs a gate delay of 2, resulting in a total gate delay of 2 log₂(N) for this parallel prefix operation section.

With the log₂(N) propagation Pⱼ and generation Gⱼ vectors calculated, an N+1-bit sum vector S[0 . . . N] can be calculated:

s₀=p_{0,0}, (18)

and for columns i=1 . . . N:

sᵢ=g_{log 2N,i-1} ⊕ p_{0,i}. (19)

FIG. 6E shows an example digital logic circuit that implements the relationships of Equations (18) and (19). The circuit, shown generally at 98, accepts initial propagation variable p_{0.0} 99, initial propagation variable p_{0,i} 101 and composite generation variable g_{log 2N,i-1} 102 as inputs and output sum bits s₀ 100 and sᵢ 35. comprises an XOR gate 103. Propagation variable p_{0,0} 99 becomes the 0^{th} sum bit s₀ 100. Initial propagation variable p_{0,i} 101 and composite generation variable g_{log 2N,i-1} 102 are inputs to XOR gate 103, resulting in the i^{th} sum bit sᵢ 35.

Thus, the calculation of the sum bits incurs two gate delays (again recognizing again that an XOR operation is equivalent to two two-input AND/OR gate delays).

It can thus be shown that the gate delay for a 2-operand N-bit KS adder is 2 log₂(N)+4 gate delays and for an N+1 KS adder, such as would be employed to perform the addition of the output of one or more levels of N-bit CSAs, is 2 log₂(N+1)+4 gate delays. This is generally considered to be the fastest two-operand N-bit adder available because it scales logarithmically. Other two-operand N-bit adders may simplify complexity of the prefix portion but at the cost of additional gate delays.

Thus, until now, the most time-efficient calculation of a sum of three N-bit operands employs a 3:2 N-bit CSA (shown in dashed outline as comprising a series of N+1 one-bit 3:2 CSAs) and an N+1-bit KS adder, such as is shown in FIG. 8. The overall gate delay of this operation is thus the sum of the gate delay of a 3:2 N-bit CSA and the gate delay of the N+1-bit KS adder, resulting in a total gate delay of 2 log₂(N+1)+8.

### BRIEF DESCRIPTION OF THE DRAWINGS

Example embodiments of the present disclosure will now be described by reference to the following figures, in which identical reference numerals in different figures indicate identical elements and in which:

FIG. 1 is a schematic view of an example configuration of a multi-level tree of N-bit 3:2 CSAs to add multiple operands to achieve a single result that represents a sum of the operands;

FIG. 2A is a truth table showing a result of binary addition of three one-bit operands in an example of a one-bit 3:2 CSA;

FIG. 2B is an example schematic representation of the one-bit 3:2 CSA of the example of FIG. 2A;

FIG. 3A is an example digital logic circuit that implements the example one-bit 3:2 CSA of the example of FIG. 2A;

FIG. 3B is an example digital logic circuit that implements the example one-bit 3:2 CSA of the example of FIG. 3A for a bit-position (0);

FIG. 3C is an example digital logic circuit corresponding to the example of FIG. 3B, but for a bit-position (1);

FIG. 4A is an example three-operand N-bit addition showing partial select and carry shift operations;

FIG. 4B is a schematic view of an example configuration for performing the example three-operand N-bit addition operation of FIG. 4A using a two-operand N+1-bit ripple carry adder;

FIG. 5 is a drawing demonstrating functional equivalence between the example one-bit 3:2 CSA of FIG. 2B and an example two-operand one-bit ripple carry adder;

FIG. 6A is a truth table showing propagation and generation variables of a carry-out bit, as a function of input operand values and of a carry-in bit;

FIG. 6B is an example digital logic circuit that generates a 0^{th} row propagation and generation variable for a given bit-position from carry and sum values for the given bit-position and a less significant bit-position;

FIG. 6C is a digital logic circuit that implements an example j^{th} row (j=1 . . . log₂ N) prefix operation generating a composite propagation variable p_{j,i} and a composite generation variable g_{j,i} from a pair of j−1^{th} row propagation variables pⱼ₋₁,ᵢ₋ₖ and pⱼ₋₁,ᵢ and a pair of j−1^{th} row generation variables gⱼ₋₁,ᵢ₋ₖ and gⱼ₋₁,ᵢ, where k=2^{j-1};

FIG. 6D is an example schematic representation of the example prefix operation of FIG. 6C;

FIG. 6E is an example digital logic circuit that implements sum bits sᵢ (i=0 . . . N) from the 0^{th} row initial propagation variables p_{0,0}, p_{0,i} and log₂(N)^{th} row composite generation variables g_{log 2(N)},ᵢ₋₁;

FIG. 7 is an example schematic representation of a prefix portion of a two-operand 8-bit Kogge-Stone adder with sparsity 1;

FIG. 8 is a schematic view of an example combination of a 3:2 N+1-bit CSA and a two-operand N+1-bit Kogge-Stone adder to calculate a sum of three N-bit operands;

FIG. 9 is a schematic view of an example embodiment of a three-operand N-bit adder according to an example embodiment of the present disclosure;

FIG. 10A is a schematic view of an example embodiment of a pre-processor shown in the example embodiment of the adder of FIG. 9;

FIG. 10B is a schematic view of the operation of a pre-processor according to the example embodiment of FIG. 10A;

FIG. 10C is an example digital logic circuit for a LSB block of the pre-processor according to the example embodiment of FIG. 10A;

FIG. 10D is an example digital logic circuit for an intermediate block of the pre-processor according to the example embodiment of FIG. 10A;

FIG. 10E is an example digital logic circuit for a MSB block of the pre-processor according to the example embodiment of FIG. 10A;

FIG. 11A is an example digital logic circuit that generates a carry bit and its inverse for bit-position (i) from the corresponding bit-position for three operands according to an example embodiment of the present disclosure;

FIG. 11B is an example digital logic circuit that generates intermediate values xᵢ₊₁ and yᵢ₊₁ and their inverses for bit-position (i+1) from the corresponding bit position for three operands according to an example embodiment of the present disclosure;

FIG. 11C is an example digital logic circuit that generates an initial propagation variable for bit-position (i) from a carry bit for bit-position (i) and intermediate values for bit-position (i+1) and their inverses according to an example embodiment of the present disclosure;

FIG. 11D is an example digital logic circuit that generates an initial generation variable for bit-position (i) from a carry bit for bit-position (i) and intermediate values for bit-position (i+1) according to an example embodiment of the present disclosure;

FIG. 12A is a schematic view of an example embodiment of a generator shown in the example embodiment of the adder of FIG. 9;

FIG. 12B is an example digital logic circuit for a first prefix calculation block of the generator according to the example embodiment of FIG. 12A;

FIG. 12C is an example digital logic circuit for a second prefix calculation block of the generator according to the example embodiment of FIG. 12A;

FIG. 13A is a schematic view of an example embodiment of a post-processor shown in the example embodiment of the adder of FIG. 9;

FIG. 13B is an example digital logic circuit that generates a sum bit for bit-positions (2) through (N) from an initial propagation variable p_{0,i}, a log₂(N)−1^{th} row propagation variable p_{log 2(N)-1,i-1} and a pair of log₂(N)−1^{th} row generation variables g_{log 2(N)-1,i-1} and g_{log 2(N)-1,i-k-1} according to an example embodiment of the present disclosure;

FIG. 13C is an example digital logic circuit for a processing block of the post-processor that is a logical equivalent to the circuit of FIG. 13B, according to the example embodiment of FIG. 13A;

FIG. 13D is an example digital logic circuit for a MSB block of the post-processor according to the example embodiment of FIG. 13A; and

FIG. 14 is a flow chart showing example actions that may be performed in accordance with an example embodiment of the present disclosure.

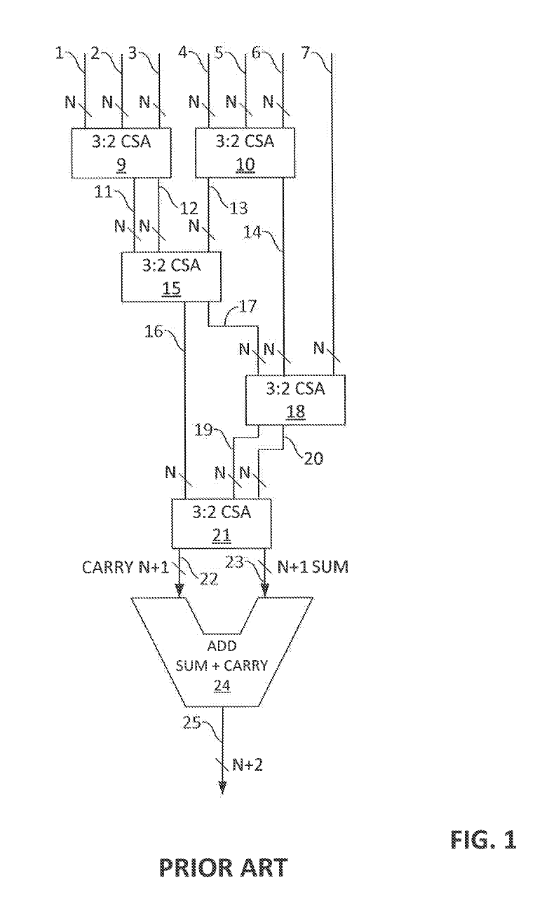

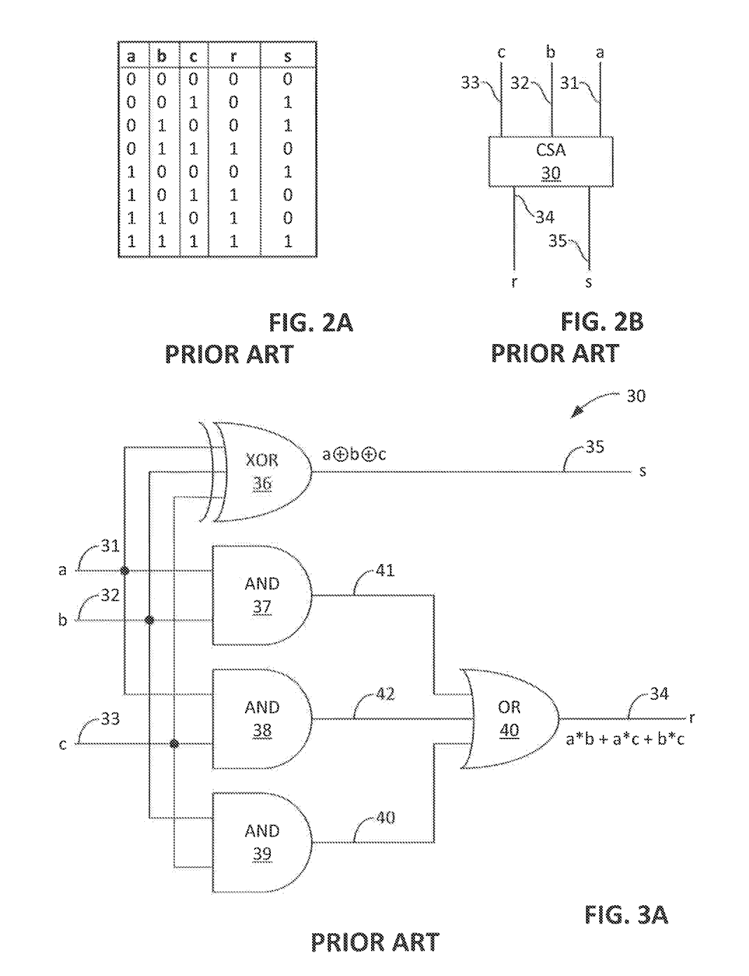

### SUMMARY

The present disclosure discloses a circuit for performing three-operand N-bit addition on two's complement numbers.

In one example-embodiment of the present disclosure, there is provided an adder for calculating a sum of three input operands. The adder has a pre-processor, a generator and a post-processor. The pre-processor creates an initial propagation vector having a plurality of bits, each bit in the plurality representing whether a carry-in bit is propagated as a carry-out bit as determined from a value of respective bits of each of the three operands. The pre-processor creates an initial generation vector having a plurality of bits, each bit in the plurality representing whether a carry-out bit is generated as determined from a value of respective bits of each of the three operands. The generator generates a composite propagation vector and a composite generation vector from parallel prefix operations on the initial propagation vector and initial generation vector. The post-processor calculates corresponding sum bits from the initial propagation vector, the composite propagation vector and the composite generation vector.

The pre-processor can comprise a pre-processing block configured to output a least significant bit s₀ of the sum. The pre-processing block can be configured to determine the least significant bit by performing logical operations that have logical equivalence with the equation:

s₀=(x₀′*y₀′)′,

where x₀ is an intermediate value that has logical equivalence with:

x₀=a₀*b₀′*c₀′+a₀′*b₀*c₀′+a₀′*b₀′*c₀,

where y₀ is an intermediate value that has logical equivalence with:

y₀=a₀*b₀*c₀, and

where a₀, b₀ and c₀ are the least significant bits of the operands.

The pre-processor can comprise a pre-processing block configured to create a corresponding i^{th} bit p_{0,i} of the initial propagation other than a most significant bit thereof, by performing logical operations that have logical equivalence with the equation:

p_{0,i}=xᵢ₊₁′*yᵢ₊₁′*rᵢ+xᵢ₊₁*rᵢ′+yᵢ₊₁*rᵢ′,

where xᵢ₊₁ is an intermediate value that has logical equivalence with:

xᵢ₊₁=aᵢ₊₁*bᵢ₊₁′*cᵢ₊₁′+aᵢ₊₁′*bᵢ₊₁*cᵢ₊₁′+aᵢ₊₁′*bᵢ₊₁′*cᵢ₊₁,

where yᵢ₊₁ is an intermediate value that has logical equivalence with:

yᵢ₊₁=aᵢ₊₁*bᵢ₊₁*cᵢ₊₁,

where rᵢ is a carry bit that has logical equivalence with:

rᵢ=aᵢ*bᵢ+aᵢ*cᵢ+bᵢ*cᵢ, and

where aᵢ, bᵢ and cᵢ are the i^{th} and aᵢ₊₁, bᵢ₊₁ and cᵢ₊₁ are the i+1^{st} bits of the operands.

The pre-processing block can be configured o create a corresponding i^{th} bit g_{0,i} of the initial generation vector other than a most significant bit thereof, by performing logical operations that have logical equivalence with the equation:

g_{0,i}=xᵢ₊₁*rᵢ+yᵢ₊₁*rᵢ.

The pre-processor can comprise a plurality of pre-processing blocks, respectively corresponding to each bit of the initial propagation vector other than the most significant bit thereof.

The pre-processing block corresponding to the least significant bit of the initial propagation vector can be configured to output a 1^{st} bit of the sum that is equal to the least significant bit, p_{0,0}, of the initial propagation vector. The sum bits calculated by the post-processor can reflect bits more significant than the 0^{th} and 1^{st} bits of the sum.

The pre-processor can comprise a pre-processing block configured to create a most significant N−1^{st} bit p_{0,N-1} of the initial propagation vector by performing logical operations that have logical equivalence with the equation:

p_{0,N-1}=a_{N-1}*b_{N-1}+a_{N-1}*c_{N-1}+b_{N-1}*c_{N-1},

where a_{N-1}, b_{N-1} and c_{N-1}, are the N−1^{st} bits of the operands.

The pre-processing block can set a most significant N−1^{st} bit of the initial generation vector to 0.

The post-processor can comprise a post-processing block configured to calculate a most significant N+1^{st} bit s_{N+1} of the sum by performing logical operations that have logical equivalence with the equation:

s_{N+1}=g_{log 2(N),N-1}+p_{log 2(N)-1,N-1}*g_{log 2(N)-1,N-k-1},

where p_{log 2(N)-1,N-1} is the most significant bit of the composite propagation vector,

where g_{log 2(N)-1,N-1} is the most significant bit of the composite generation vector, and

where g_{log 2(N)-1,N-k-1} is the N−k−1^{st} bit of the composite generation vector.

The post-processor can comprise a post-processing block configured to calculate a corresponding bit of the sum sᵢ other than the most significant bit, a least significant bit and a 1^{st} bit of the sum by performing logical operations, that have logical equivalence with the equation:

sᵢ=p_{0,i} ⊕ (p_{log 2(N)-1,i-1}*g_{log 2(N)-1,i-1}+g_{log 2(N)-1,i-k-1}),

where p_{0,i} is an i^{th} bit-position of the initial propagation vector,

where p_{log 2(N)-1,i-1} is an i−1^{st} bit-position of the composite propagation vector,

where g_{log 2(N)-1,i-1} is an i−1^{st} bit-position of the composite generation vector, and

where g_{log 2(N)-1,i-k-1} is an i−k−1^{st} bit-position of the composite generation vector.

In one example-embodiment of the present disclosure, there is provided a method for calculating a sum of three input operands. The method comprises actions of creating an initial propagation vector, creating an initial generation vector, generating a composite propagation vector and a composite generation vector and calculating a sum. The initial propagation vector has a plurality of bits, each bit in the plurality representing whether a carry-in bit is propagated as a carry-out bit as determined from a value of respective bits of each of the three operands. The initial generation vector has a plurality of bits, each bit in the plurality representing whether a carry-out bit is generated as determined from a value of respective bits of each of the three operands. The composite propagation vector and composite generation vector are created from parallel prefix actions on the initial propagation vector, the composite propagation vector and the composite generation vector.

The action of creating an initial propagation vector can comprise outputting a least significant bit s₀ of the sum. The action of outputting can comprise performing logical operations that have logical equivalence with the equation:

s₀=(x₀′*y₀′)′,

x₀=a₀*b₀′*c₀′+a₀′*b₀*c₀′+a₀′*b₀′*c₀,

where y₀ is an intermediate value that has logical equivalence with:

y₀=a₀*b₀*c₀, and

where a₀, b₀ and c₀ are the least significant bits of the operands.

The action of creating an initial propagation vector can comprise generating a corresponding i^{th} bit p_{0,i} of the initial propagation other than a most significant bit thereof, by performing logical operations that have logical equivalence with the equation:

p_{0,i}=xᵢ₊₁′*yᵢ₊₁′*rᵢ+xᵢ₊₁*rᵢ′+yᵢ₊₁*rᵢ′,

where xᵢ₊₁ is an intermediate value that has logical equivalence with:

xᵢ₊₁=aᵢ₊₁*bᵢ₊₁′*cᵢ₊₁′+aᵢ₊₁′*bᵢ₊₁*cᵢ₊₁′+aᵢ₊₁′*bᵢ₊₁′*cᵢ₊₁,

where yᵢ₊₁ is an intermediate value that has logical equivalence with:

yᵢ₊₁=aᵢ₊₁*bᵢ₊₁*cᵢ₊₁,

where rᵢ is a carry bit that has logical equivalence with:

rᵢ=aᵢ*bᵢ+aᵢ*cᵢ+bᵢ*cᵢ, and

where aᵢ, bᵢ and cᵢ are the i^{th} and aᵢ₊₁, bᵢ₊₁ and cᵢ₊₁ are the i+1^{st} bits of the operands.

The action of creating an initial generation vector can comprise generating a corresponding i^{th} bit g_{0,i} of the initial generation vector other than a most significant bit thereof, by performing logical operations that have logical equivalence with the equation:

g_{0,i}=xᵢ₊₁*rᵢ+yᵢ₊₁*rᵢ.

The action of generating a corresponding i^{th} bit p_{0,i} can comprise outputting a 1^{st} bit of the sum that is equal to the least significant bit, p_{0,0}, of the initial propagation vector. The action of calculating the sum can comprise calculating sum bits more significant than the 0^{th} and 1^{st} bits of the sum.

The action of creating an initial propagation vector can comprise generating a most significant N−1^{st} bit p_{0,N-1} of the initial propagation vector by performing logical operations that have logical equivalence with the equation:

p_{0,N-1}=a_{N-1}*b_{N-1}+a_{N-1}*c_{N-1}+b_{N-1}*c_{N-1},

where a_{N-1}, b_{N-1} and c_{N-1}, are the N−1^{st} bits of the operands.

The action of creating an initial generation vector can comprise setting a most significant N−1^{st} bit of the initial generation vector to 0.

The action of calculating the sum can comprise calculating a most significant N+1^{st} bit s_{N+1} of the sum by performing logical operations that have logical equivalence with the equation:

s_{N+1}=g_{log 2(N),N-1}+p_{log 2(N)-1,N-1}*g_{log 2(N)-1,N-k-1},

where p_{log 2(N)-1,N-1} is the most significant bit of the composite propagation vector,

where g_{log 2(N)-1,N-1} is the most significant bit of the composite generation vector, and

where g_{log 2(N)-1,N-k-1} is the N−k−1^{st} bit of the composite generation vector.

The action of calculating the sum can comprise calculating a corresponding bit of the sum sᵢ other than the most significant bit, a least significant bit and a 1^{st} bit of the sum by performing logical operations, that have logical equivalence with the equation:

sᵢ=p_{0,i} ⊕ (p_{log 2(N)-1,i-1}*g_{log 2(N)-1,i-1}+g_{log 2(N)-1,i-k-1}),

where p_{0,i} is an i^{th} bit-position of the initial propagation vector,

where p_{log 2(N)-1,i-1} is an i−1^{st} bit-position of the composite propagation vector,

where g_{log 2(N)-1,i-1} is an i−1^{st} bit-position of the composite generation vector, and

where g_{log 2(N)-1,i-k-1} is an i−k−1^{st} bit-position of the composite generation vector.

### DESCRIPTION

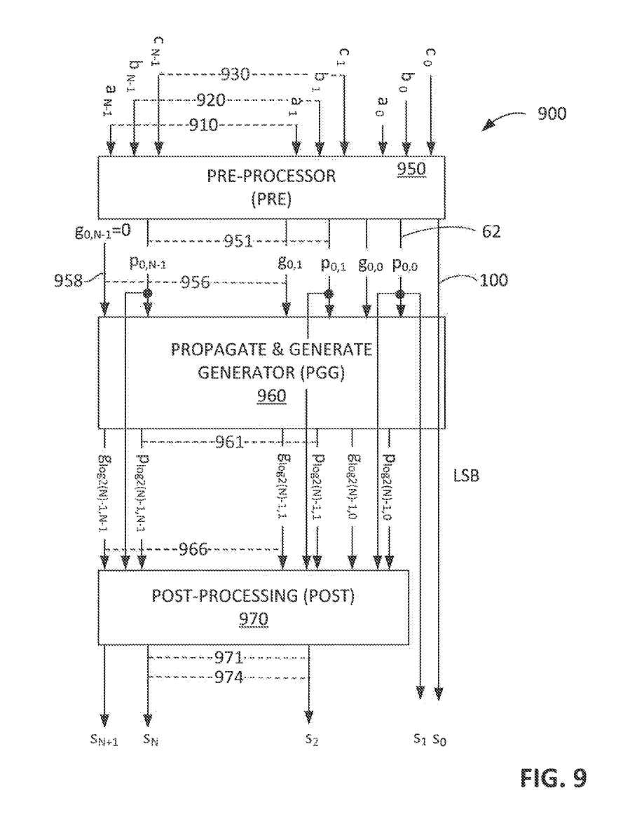

A first example embodiment of a three-operand N-bit adder circuit is disclosed in FIG. 9.

The disclosed three-operand adder may be used for the addition of three partial products thus dispensing with a 3:2 N+1-bit CSA as well as the two-operand N+1-bit adder combination in the final level of a multiple N-bit operand addition (such as is typical in accumulating partial products to effect parallel multiplication operations), thus reducing gate delays on a critical path.

The adder dispenses with the generation of sum and carry bit vectors, conventionally performed by the 3:2 compression of a CSA, by simultaneously performing 3:2 compression and generating an initial propagation vector of 0^{th} row propagation variables and an initial generation vector of 0^{th} row generation variables.

Further, the adder calculates the sum bits from the final composite generation vector (row log₂ N) generation variables in conjunction with the final composite propagation vector (row log₂ N), and the initial propagation vector (row 0) of propagation variables.

The combination of these two measures shortens the delay path between the input and output to accelerate circuit performance. The disclosed three-operand adder has an overall gate delay of 2 log₂(N)+4, resulting in a shorter critical path and greater throughput.

The adder has small logic depth and is suitable for low area VLSI circuit implementations employing regular architecture to accelerate computing power. It exhibits regular fanout and thus exhibits predictable but improved performance when substituted for conventional 3:2 CSA and two-input adder combinations.

The adder, shown generally at 900, accepts three N-bit two's complement operands A 910, B 920 and C 930. Each operand A 910, B 920, C 930 comprises a plurality of N bits, each designated by bit-position from an LSB, denoted 0, to a MSB, denoted N−1. The adder 900 generates a single N+2-bit two's complement sum vector S 940, designated by bit-position, from an LSB denoted 0 to a MSB denoted N+1.

The adder 900 comprises a pre-processor 950, a generator 960 and a post-processor 970.

The pre-processor 950 accepts as inputs the three operands A[0 . . . N−1] 910, B[0 . . . N−1] 920 and C [0 . . . N−1] 930 and outputs an initial N-bit propagation vector P₀[0 . . . N−1] 951 and an initial N-bit generation vector G₀[0 . . . N−1] 956. The pre-processor 950 also calculates the LSB of sum vector S[0 . . . N+1], namely s₀ 100. As is shown by FIG. 9, the LSB of P₀[0 . . . N−1], namely p_{0,0} 62, also forms the NSB of s₀ 100, namely s₁ 62. As is shown by FIG. 9, the MSB of G₀[0 . . . N−1] 956, namely g_{0,N-1} 958 is not employed to calculate either propagation variables in subsequent propagation vectors Pⱼ[0 . . . N−1], generation variables in subsequent generation vectors Gⱼ[0 . . . N−1] or sum bits in sum vector S[0 . . . N+1] and as such is shown as “0”. Alternatively, the initial generation vector may omit the MSB, and thus be denoted as G₀[0 . . . N−2].

The pre-processor 950 performs parallel addition of the operands to calculate the initial propagation vector P₀[0 . . . N−1] 951 and initial generation vector G₀[0 . . . N−1] 956, for input into the generator 960. As the LSB s₀ 100 and its NSB s₁ 62 of the sum vector S[0 . . . N+1] also fall out of the operation of the pre-processor 950, these are provided to the output of the adder 900.

As will be seen, the pre-processor 950 has a gate delay of 4.

The generator 960 accepts as inputs the initial propagation vector P₀[0, N−1] 951 and initial generation vector G₀[0, N−1] 956, calculates intermediate propagation p_{j,i} and generation g_{j,i} variables from the initial propagation vectors P₀[0, N−1] 951 and initial generation vector G₀[0, N−1] 956 and outputs an N-bit composite propagation vector P_{log 2(N)-1}[0 . . . N−1] 961 and an N-bit composite generation vector G_{log 2(N)-1}[0 . . . N−1] 966. The composite propagation vector P_{log 2(N)-1}[0 . . . N−1] 961 and composite generation vector G_{log 2(N)-1}[0 . . . N−1] 966 incorporate the results of all parallel prefix operations of the initial propagation vector P₀[0 . . . N−1] 951 and of the initial generation vector G₀[0 . . . N−1] 956 on the operands A[0 . . . N−1] 910, B[0 . . . N−1] 920 and C[0 . . . N−1] 930.

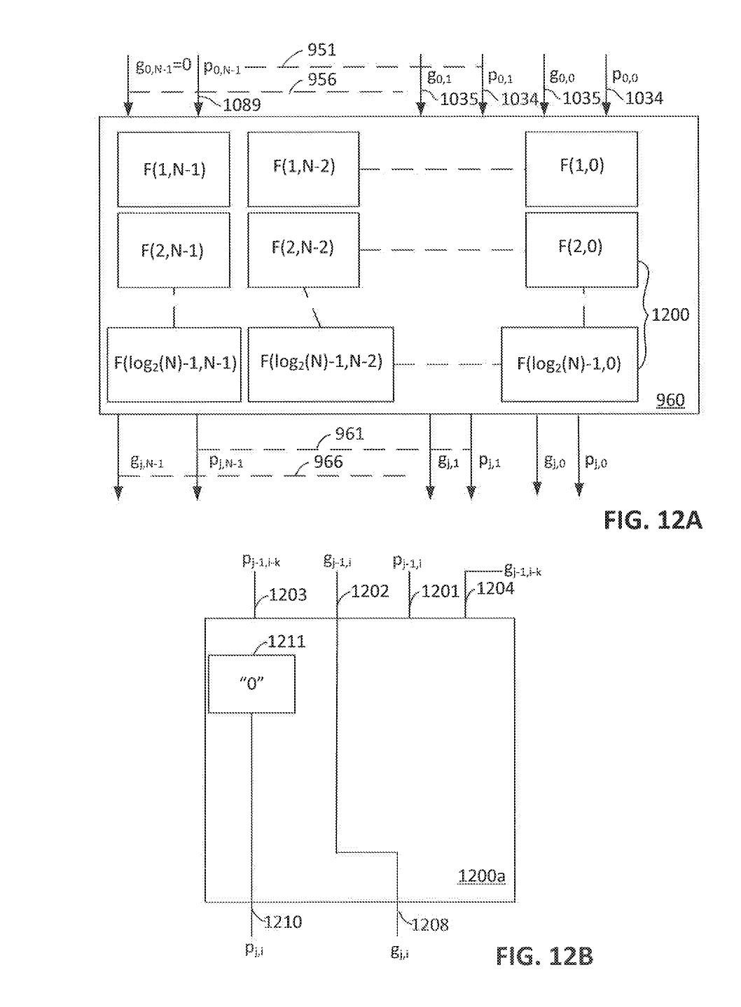

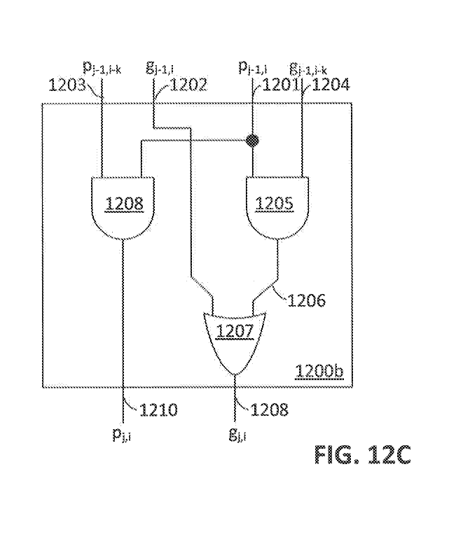

As will be seen, the generator 960 comprises an array of log₂(N)−1 rows of N processing blocks 1200 (shown in FIG. 12A). Each processing block 1200 has a gate delay of 2. Accordingly, the generator 960 has a gate delay is 2 log₂(N)−2.

The post-processor 970 accepts as inputs the composite propagation vector P_{log 2(N)-1}[0 . . . N−1] 961, the composite generation vector G_{log 2(N)-1}[0 . . . N−1] 966 and the initial propagation vector P₀[0 . . . N−1] 951 and generates the remaining N bit-positions of the sum vector S[2 . . . N+1] 971, for combination with s₀ 100 and s₁ 62 to form the complete N+2-bit sum vector S[0 . . . N+1] 940.

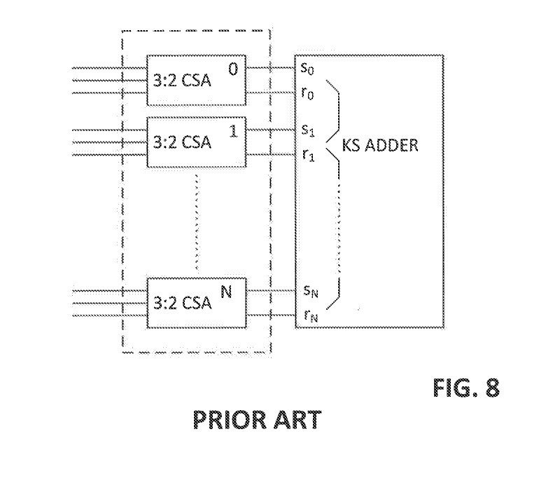

As will be seen, the post-processor 970 has a gate delay of 2. Accordingly, it can be seen that the overall gate delay for the adder 900 is log₂(N)+4, resulting in a savings of 4 gate delays over the combination of a 3:2 CSA and a two-input KS adder, such as is shown in FIG. 8.

The savings in gate delay is partially achieved in the pre-processor 950, through the creation of the initial propagation vector P₀[0 . . . N−1] 951 and initial generation vector G₀[0 . . . N−1] 956, but for all three operands, without explicit calculation of sum and carry vectors. Parallel prefix computation is performed in the generator 960 on the initial propagation vector P₀[0 . . . N−1] 951 and initial generation vector G₀[0 . . . N−2] 956 to generate the composite propagation vector P_{log 2(N)-1}[0 . . . N−1] 961 and the composite generation vector G_{log 2(N)-1}[0 . . . N−1] 966. Further savings in gate delay is achieved in the post-processor 970, which operates on the composite propagation vector P_{log 2(N)-1}[0 . . . N−1] 961 and the composite generation vector G_{log 2(N)-1}[0 . . . N−1] 966 together with the initial propagation vector P₀[0,N−1] 951 to generate the remaining N bit-positions of the sum vector S[2 . . . N+2] 971, effectively consolidating in one place XOR operations (or logical equivalents thereof) conventionally performed both in parallel prefix operations and in generating the ultimate sum so as to avoid duplication and delay.

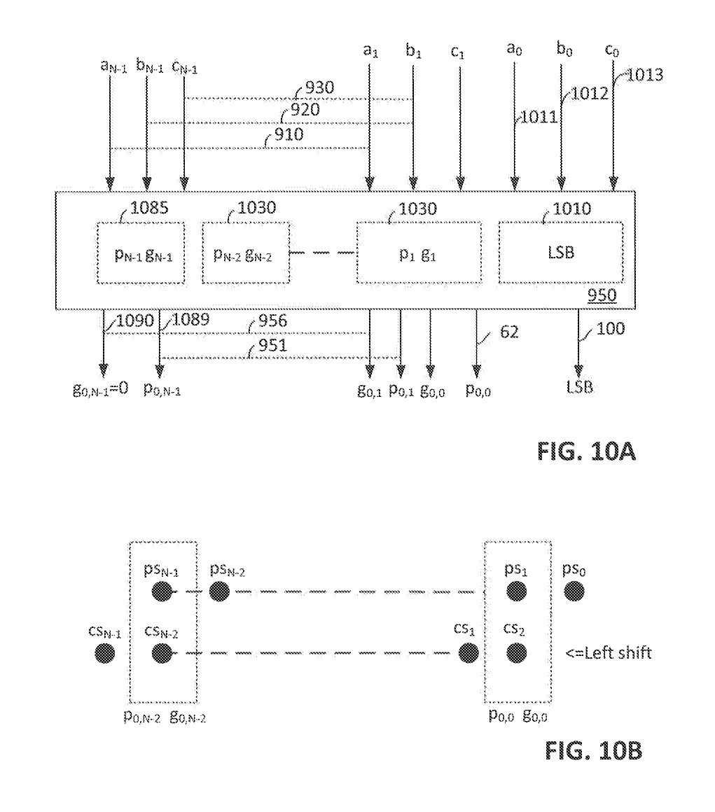

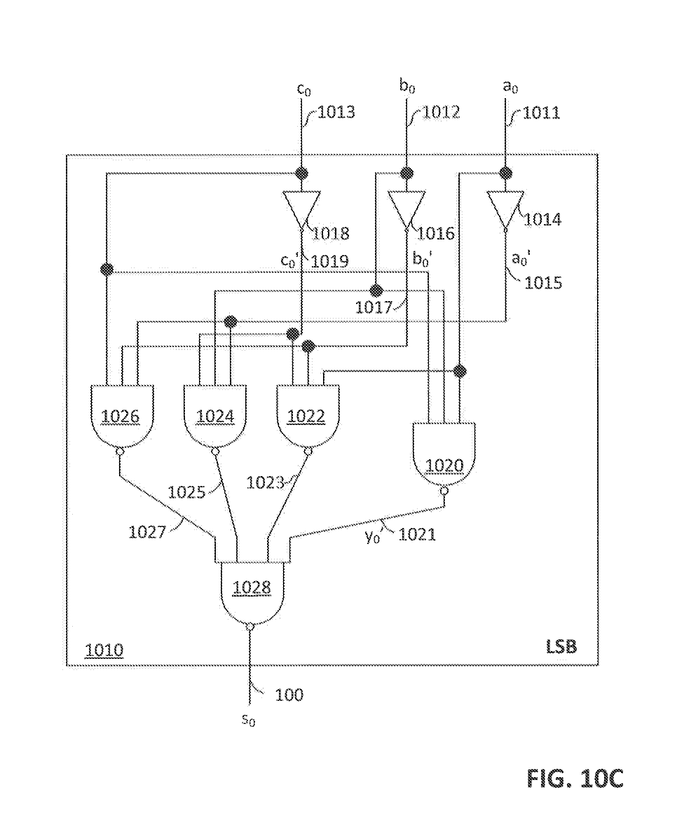

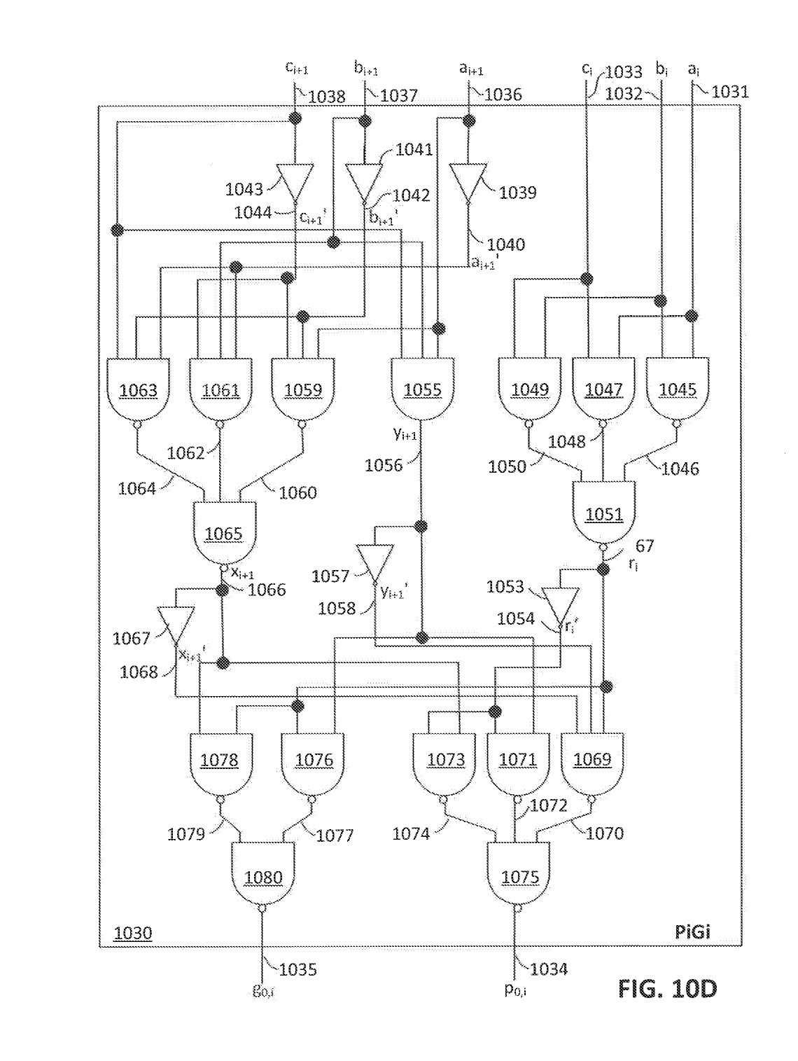

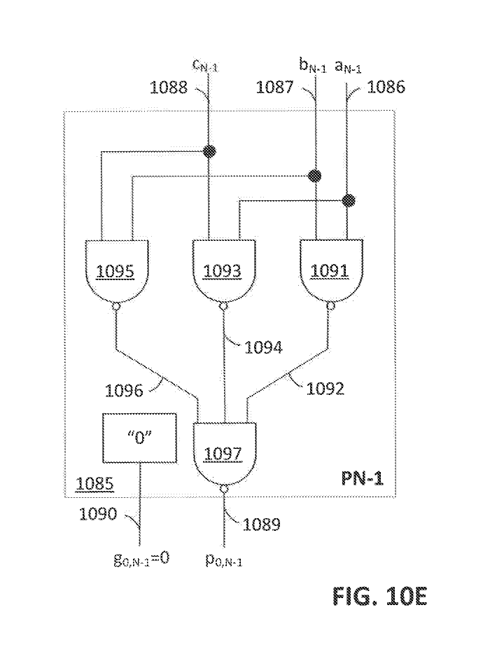

Turning now to FIG. 10A, there is shown a schematic view of an example embodiment of the pre-processor 950. The pre-processor 950 generates the initial propagation vector P₀[0 . . . N−1] 951 and initial generation vector G₀[0 . . . N−1] 956. As the LSB s₀ 100 and its NSB s₁ 62 of the sum S[0 . . . N+1] also fall out of the operation of the pre-processor 950, these are provided to the output of the adder 900.

The pre-processor 950 comprises N pre-processing blocks 1010, 1030, 1085. The first pre-processing block 1010 accepts as inputs, the LSB of the three operands, namely a₀ 1011, b₀ 1012 and c₀ 1013, and generates a single output, namely the LSB of the sum vector S[0 . . . N+1] s₀ 100.

The last pre-processing block 1085 accepts as inputs, the MSB of the three operands, namely a_{N-1} 1086, b_{N-1} 1087 and c_{N-1} 1088, and generates two outputs, the MSB of an initial propagation vector P₀[0 . . . N−1] 961, namely p_{0,N-1} 1089, and the MSB of an initial generation vector G₀[0 . . . N−1] 966, namely g_{0,N-1} 1090, which is set to 0.

The N−1 remaining pre-processing blocks 1030 respectively correspond to the N−1 remaining bit-positions from (0) to (N−2). Each processing block 1030 accepts as inputs its respective three operands, namely aᵢ 1031, bᵢ 1032 and cᵢ 1033, as well as the three NSB operands, namely aᵢ₊₁ 1036, bᵢ₊₁ 1037 and cᵢ₊₁ 1038 (as shown on FIG. 10D), and generates two outputs, namely the corresponding bit-position (i) p_{0,i} 1034 of the initial propagation vector Pₒ[0 . . . N−1] 951 and the corresponding bit-position (i) g_{0,i} 1035 of the initial generation vector G₀[0 . . . N−1] 956, where g_{0,N-1} 1090 is unused and set to 0. Alternatively, one may consider the initial generation vector to be G₀[0 . . . N−2].

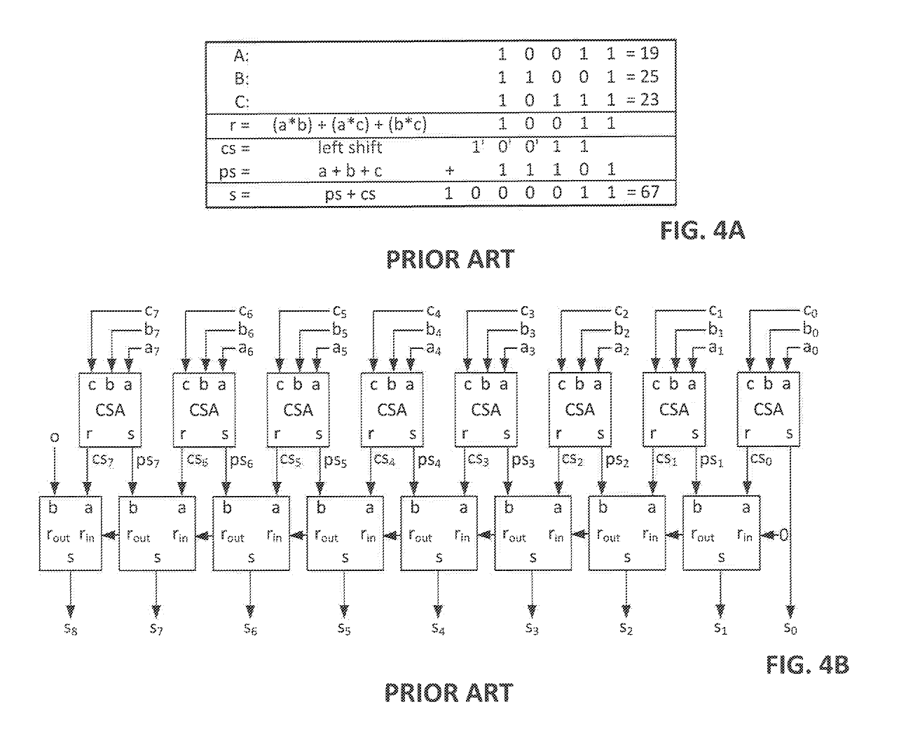

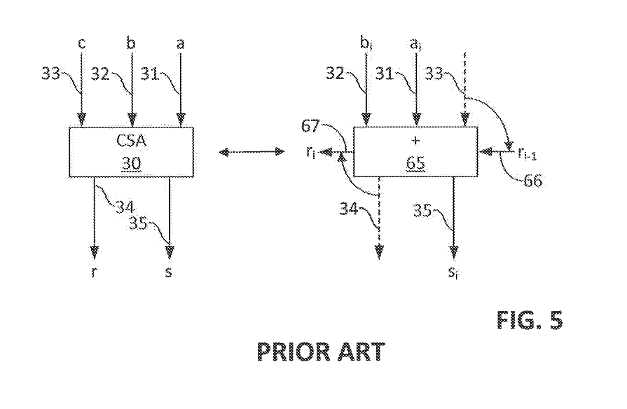

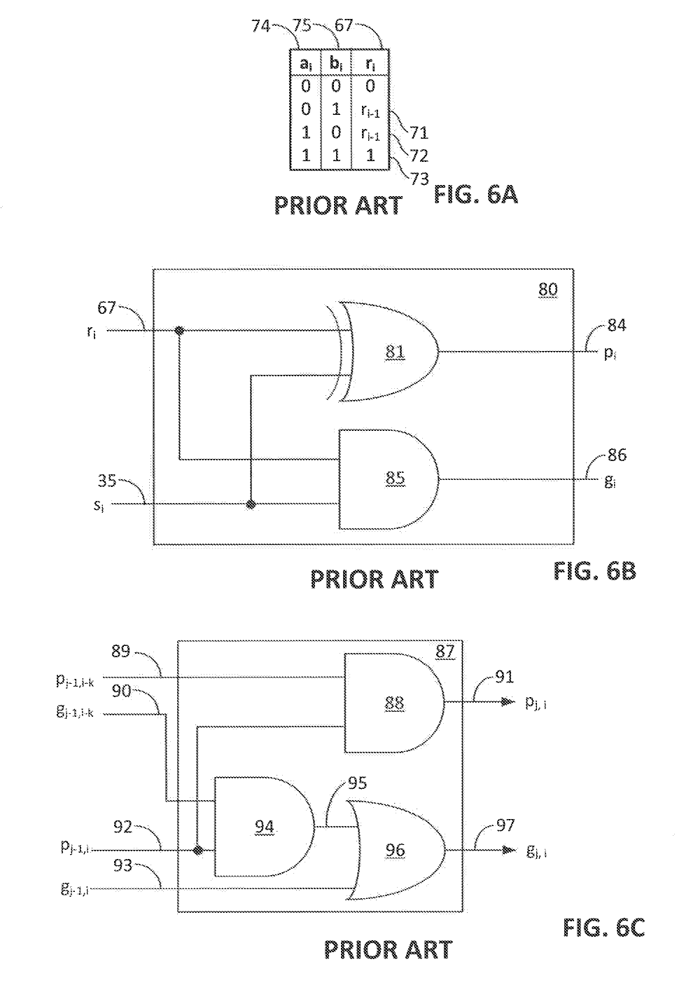

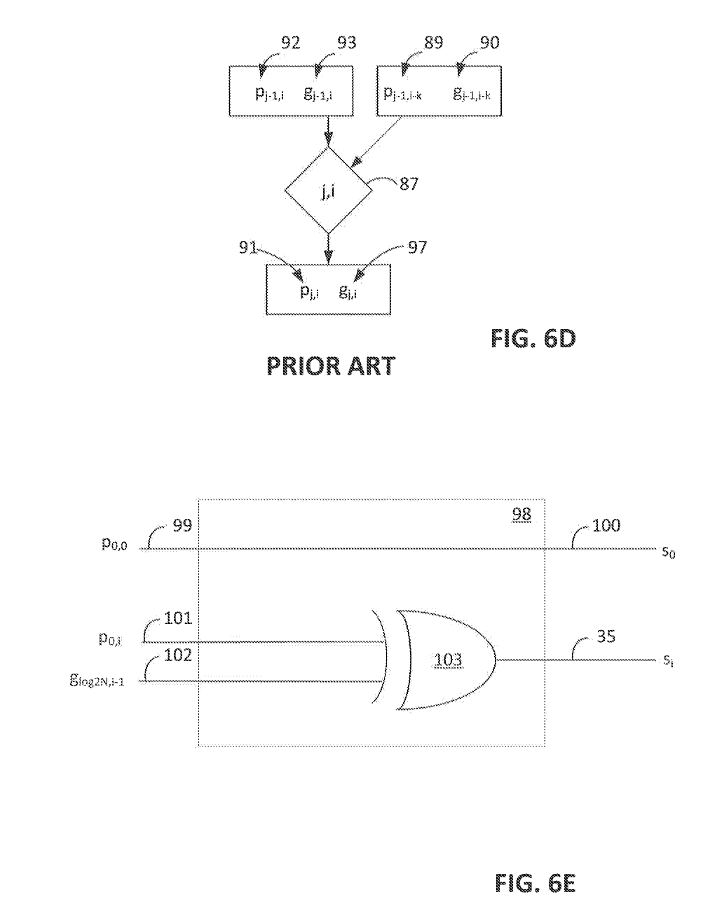

With reference to the example shown in FIG. 4A, FIG. 10B shows schematically how the pre-processor 950 operates on a bit-wise basis to generate propagation p_{0,i} and generation g_{0,i} variables. When performing bit-wise addition of the three N-bit operands A[0 . . . N−1] 910, B[0 . . . N−1] 920 and C[0 . . . N−1] 930, an N-bit partial sum vector PS[0 . . . N−1] is generated, as well as a carry shift vector CS[0 . . . N−1].

As demonstrated by Equations (12) and (13), p_{0,i} and g_{0,i} may be obtained from manipulation of sᵢ and rᵢ, that is, from manipulation of psᵢ and csᵢ₋₁.

Thus, the carry shift vector CS[0 . . . N−1] is left-shifted (multiply by 2) so that each bit-position of the partial sum vector PS[0 . . . N−1] lines up with the corresponding PSB of the carry shift vector CS[0 . . . N−1].

The derivation of how the initial propagation p_{0,i} and generation g_{0,i} variables are generated will follow later, after some further derivations.

First, it can be shown that, using Boolean algebra, equations (3) and (4) can be extended to more than two operands and that in particular, for three operands, on a bit-wise basis:

pᵢ=aᵢ ⊕ bᵢ ⊕ cᵢ, (20)

gᵢ=aᵢ*bᵢ*cᵢ. (21)

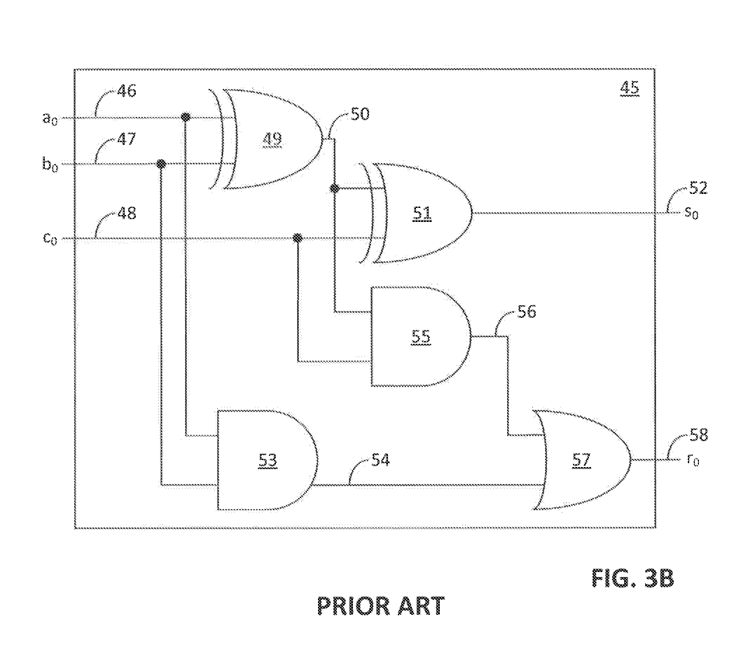

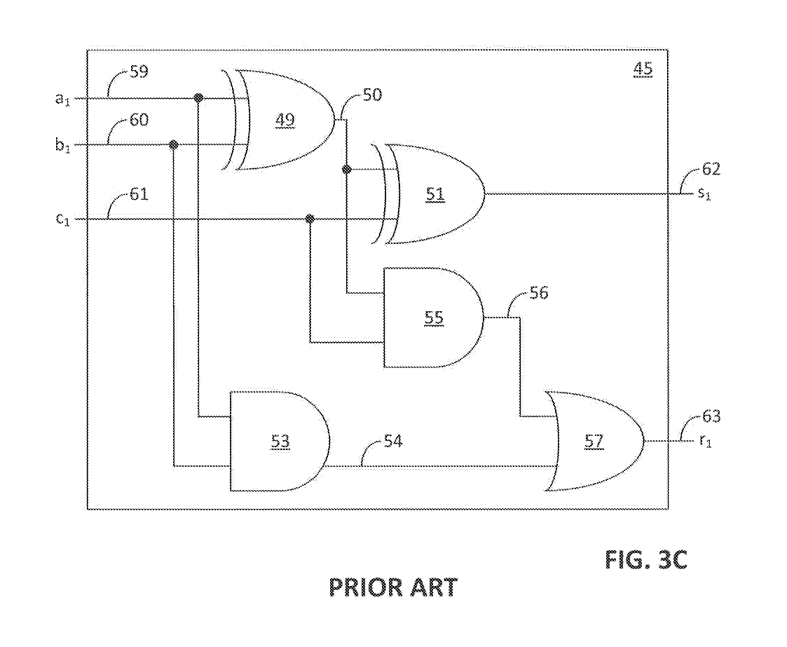

It can be shown, from Equation (1) and consideration of FIGS. 3B and 3C, that:

s₀=(a₀ ⊕ b₀) ⊕ c₀, (22)

r₀=(a₀*b₀)+((a₀ ⊕ b₀)*c₀). (23)

s₁=(a₁ ⊕ b₁) ⊕ c₁, (24)

r₁=(a₁*b₁)+((a₁ ⊕ b₁)*c₁). (25)

Second, Equations (22) through (25) may be rewritten, using known Boolean algebraic manipulations, in a form that dispenses with XOR operations (having a gate delay of 2), in favor of conjunction (AND and/or NAND) and disjunction (OR and/or NOR) operations, which have a gate delay of 1. These manipulations facilitate layout of the circuit elements by using a predominant form of gate (in the example embodiments shown, a NAND gate) that are easily reproducible in quantity in digital logic and take advantage of parallel processing available in digital logic circuits to reduce the overall processing gate delay:

sᵢ=(aᵢ*bᵢ′*cᵢ′+aᵢ′*bᵢ*cᵢ′+aᵢ′*bᵢ′*cᵢ)+aᵢ*bᵢ*cᵢ, (26)

sᵢ₊₁=(aᵢ₊₁*bᵢ₊₁′*cᵢ₊₁′+aᵢ₊₁′*bᵢ₊₁*cᵢ₊₁′+aᵢ₊₁′*bᵢ₊₁′*cᵢ₊₁)+aᵢ₊₁*bᵢ₊₁*cᵢ₊₁, (27)

rᵢ=aᵢ*bᵢ+aᵢ*cᵢ+bᵢ*cᵢ, (28)

rᵢ₊₁=aᵢ₊₁*bᵢ₊₁+aᵢ₊₁*cᵢ₊₁+bᵢ₊₁*cᵢ₊₁, (29)

where ′ denotes the NOT or inversion operation.

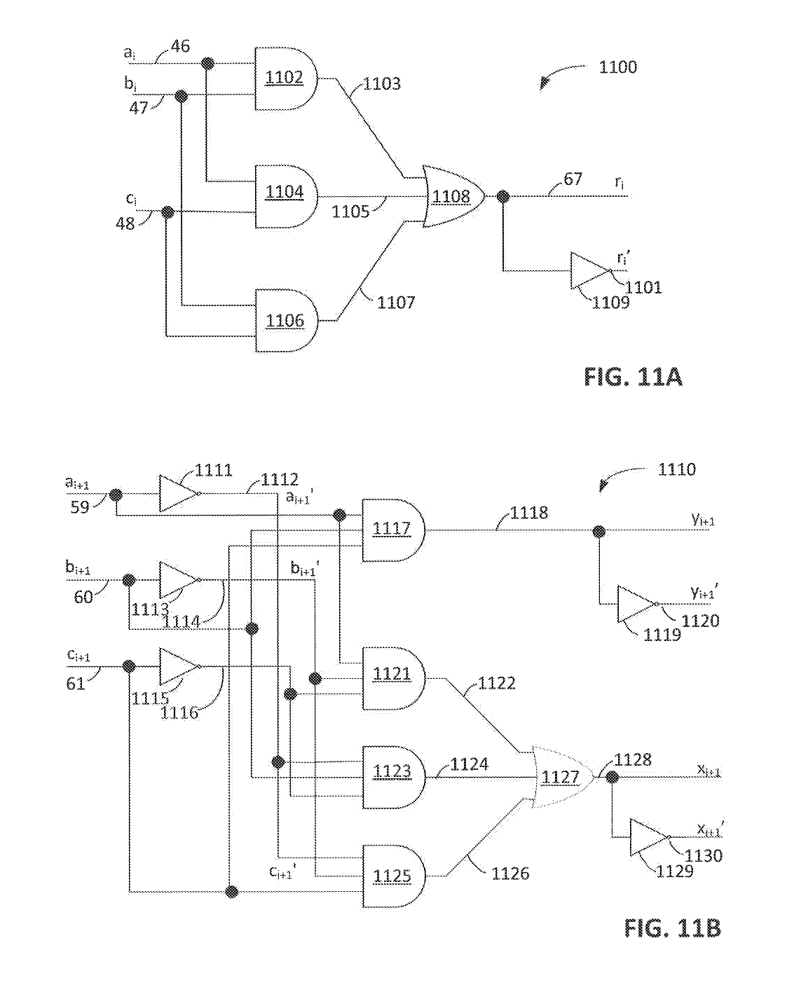

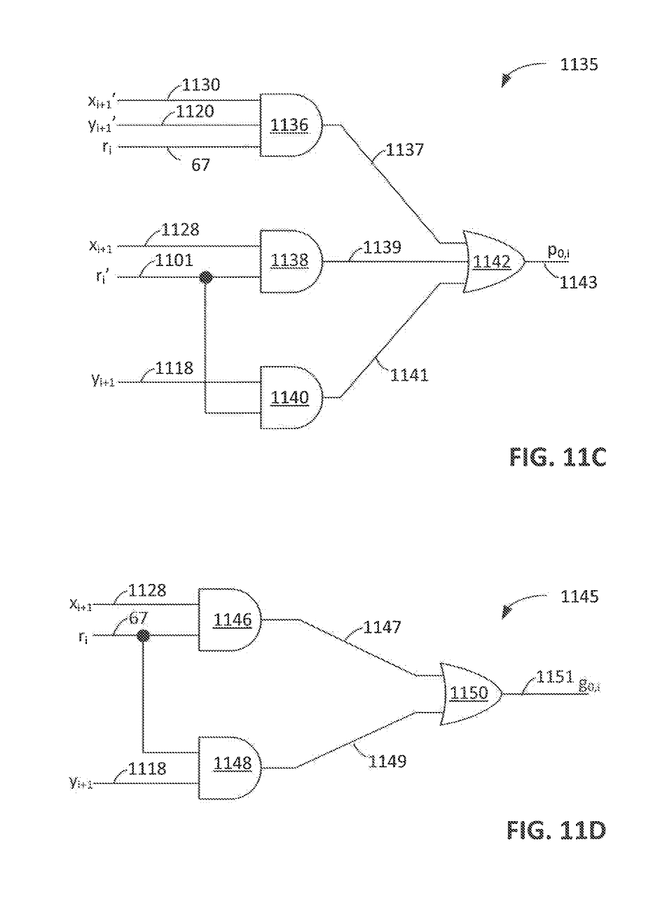

FIG. 11A shows an example digital circuit that implements Equation (28). The circuit, shown generally at 1100, comprises three AND gates 1102, 1104, 1106, an OR gate 1108 and an inverter 1109, accepts as inputs the i^{th} bit-position operands aᵢ 46, bᵢ 47 and cᵢ 48 and outputs the i^{th} bit-position carry bit rᵢ 67 and its inverse rᵢ′ 1101. Operands aᵢ 46 and bᵢ 47 are inputs to AND gate 1102, resulting in an output 1103. Operands aᵢ 46 and cᵢ 48 are inputs to AND gate 1104, resulting in an output 1105. Operands bᵢ 47 and cᵢ 48 are inputs to AND gate 1106, resulting in an output 1107. Outputs 1103, 1105 and 1107 are inputs to OR gate 1108, resulting in carry bit rᵢ 67. Carry bit rᵢ 67 is input to inverter 1109, resulting in inverted carry bit rᵢ′ 1101.

Third, intermediate values xᵢ and yᵢ are defined in order to facilitate implementation of Equation (27) in digital logic:

xᵢ=aᵢ*bᵢ′*cᵢ′+aᵢ′*bᵢ*cᵢ′+aᵢ′*bᵢ′*cᵢ, (30)

yᵢ=aᵢ*bᵢ*cᵢ. (31)

It follows that Equation (27) can be rewritten as:

sᵢ₊₁=xᵢ₊₁+yᵢ₊₁, (32)

FIG. 11B shows an example digital circuit that implements Equations (30) and (31) for bit-position (i+1). The circuit, shown generally at 1110, comprises five inverters 1111, 1113, 1115, 1119, 1129, four AND gates 1117, 1121, 1123, 1125, and an OR gate 1127, accepts as inputs the i+1^{st} bit-position operands aᵢ₊₁ 59, bᵢ₊₁ 60 and cᵢ₊₁ 61 and outputs intermediate values xᵢ₊₁ 1128 and yᵢ₊₁ 1118 and their respective inverses xᵢ₊₁′ 1130 and yᵢ₊₁′ 1120. Operand aᵢ₊₁ 59 is an input to inverter 1111, resulting in an inverted operand aᵢ₊₁′ 1112. Operand bᵢ₊₁ 60 is an input to inverter 1113, resulting in an inverted operand bᵢ₊₁′ 1114. Operand cᵢ₊₁ 61 is an input to inverter 1115, resulting in an inverted operand cᵢ₊₁′ 1116. Operands aᵢ₊₁ 59, bᵢ₊₁ 60 and cᵢ₊₁ 61 are inputs to AND gate 1117, resulting in an intermediate value yᵢ₊₁ 1118. Intermediate value yᵢ₊₁ 1118 is an input to inverter 1119, resulting in an inverted intermediate value yᵢ₊₁′ 1120. Operand aᵢ₊₁ 59 and inverted operands bᵢ₊₁′ 1114 and cᵢ₊₁′ 1116 are inputs to AND gate 1121, resulting in an output 1122. Operand bᵢ₊₁ 60 and inverted operands aᵢ₊₁′ 1112 and cᵢ₊₁′ 1116 are inputs to AND gate 1123, resulting in an output 1124. Operand cᵢ₊₁ 61 and inverted operands aᵢ₊₁′ 1112 and bᵢ₊₁′ 1114 are inputs to AND gate 1125, resulting in an output 1126. Outputs 1122, 1124 and 1126 are inputs to OR gate 1127, resulting in an intermediate value xᵢ₊₁ 1128. Intermediate value xᵢ₊₁ 1128 is an input to inverter 1129, resulting in an inverted intermediate value xᵢ₊₁′ 1130.

Fourth, from Equations (12) (extended to the general case) and (32), the initial propagation variable p_{0,i} may be rewritten as a function of the carry bit rᵢ and the intermediate variables xᵢ₊₁ and yᵢ₊ᵢ:

p_{0,i}=rᵢ*sᵢ₊₁′+rᵢ′*sᵢ₊₁, (33)

p_{0,i}=rᵢ*(xᵢ₊₁+yᵢ₊₁)′+rᵢ′*(xᵢ₊₁+yᵢ₊₁),\p (34)

p_{0,i}=xᵢ₊₁′*yᵢ₊₁′*rᵢ+xᵢ₊₁*rᵢ′+yᵢ₊₁*rᵢ′. (35)

FIG. 11C shows an example digital circuit that implements Equation (35). The circuit, shown generally at 1135, comprises three AND gates 1136, 1138, 1140 and an OR gate 1142, accepts as inputs intermediate values xᵢ₊₁ 1128, xᵢ₊₁′ 1130, yᵢ₊₁ 1118, yᵢ₊₁′ 1120 and carry bit rᵢ 67 and its inverse rᵢ′ 1101 and outputs initial propagation variable p_{0,i} 1143. Intermediate values xᵢ₊₁′ 1130 and yᵢ₊₁′ 1120 and carry bit rᵢ 67 are inputs to AND gate 1136, resulting in an output 1137. Intermediate value xᵢ₊₁ 1128 and inverted carry bit rᵢ′ 1101 are inputs to AND gate 1138, resulting in an output 1139. Intermediate value yᵢ₊₁ 1118 and inverted carry bit rᵢ′ 1101 are inputs to AND gate 1140, resulting in an output 1141. Outputs 1137, 1139 and 1141 are inputs to OR gate 1142, resulting in initial propagation variable p_{0,i} 1143.

Fifth, similarly, from Equations (13) (extended to the general case) and (32), the initial generation variable g_{0,i} may be rewritten as a function of the carry bit rᵢ and the intermediate variables xᵢ₊₁ and yᵢ₊₁:

g_{0,i}=rᵢ*(xᵢ₊₁+yᵢ₊₁), (36)

g_{0,i}=xᵢ₊₁*rᵢ+yᵢ₊₁*rᵢ. (37)

FIG. 11D shows an example digital circuit that implements Equation (37). The circuit, shown generally at 1145, comprises two AND gates 1146, 1148 and an OR gate 1150, accepts as inputs intermediate values xᵢ₊₁ 1128 and yᵢ₊₁ 1118 and carry bit rᵢ 67 and outputs initial generation variable g_{0,i} 1151. Intermediate value xᵢ₊₁ 1128 and carry bit rᵢ 67 are inputs to an AND gate 1146, resulting in an output 1147. Intermediate value yᵢ₊₁ 1118 and carry bit rᵢ 67 are inputs to an AND gate 1148, resulting in an output 1149. Outputs 1147 and 1149 are inputs to an OR gate 1150, resulting in initial generation variable g_{0,i} 1151.

From the foregoing, the derivation of the initial propagation p_{0,i} and generation g_{0,i} variables shown in FIG. 10B may now be shown., Equations (35) and (37) may be rewritten using the notation adopted in FIG. 10B:

p_{0,i}=(xᵢ₊₁+yᵢ₊₁)′*csᵢ+csᵢ′*(xᵢ₊₁+yᵢ₊₁), (38)

g_{0,i}=xᵢ₊₁*csᵢ+yᵢ₊₁*csᵢ, (39)

Furthermore, example structures of the pre-processing blocks 1010, 1030, 1085 may now be demonstrated. The example structures make use of conjunction operations in the form of NAND gates. Those having ordinary skill in this art will readily appreciate that alternate formulations, employing other conjunction operations, such as AND gates and/or disjunction operations, in the form of NOR gates and/or OR gates, may be appropriate in some example embodiments.

With respect to the first pre-processing block 1010, the LSB sum bit s₀ may be derived from Equations (30)-(32):

sₐ=s₀=x₀+y₀, (40)

By operation of DeMorgan's laws (“the negation of a conjunction is the disjunction of the negations” and “the negation of a disjunction is the conjunction of the negations”):

s₀=(x₀′*y₀′)′. (41)

Thus, substituting for x₀ and y₀:

s₀=((a₀*b₀′*c₀′)+(a₀′*b₀*c₀′)+(a₀′*b₀′*c₀))′*(a₀*b₀*c₀)′. (42)

Re-applying DeMorgan's laws to the x₀ portion, an alternate formulation for the LSB sum bit s₀, using conjunction operations (in the form of NAND gates), may be derived:

s₀=(a₀*b₀′*c₀′)′*(a₀′*b₀*c₀′)′*(a₀′*b₀′*c₀)′*(a₀*b₀*c₀)′. (43)

FIG. 10C shows the first pre-processing block 1010 in greater detail. It implements Equation (43) and comprises three inverters 1014, 1016, 1018 and five NAND gates 1020, 2022, 1024, 1026, 1028 to generate the LSB sum bit s₀ 100. Operand a₀ 1011 is an input to inverter 1014, resulting in an inverted operand a₀′ 1015. Operand b₀ 1012 is an input to inverter 1016, resulting in an inverted operand b₀′ 1017. Operand c₀ 1013 is an input to inverter 1018, resulting in an inverted operand c₀′ 1019. Operands a₀ 1011, b₀ 1012 and c₀ 1013 are inputs to NAND gate 1020, resulting in an inverted intermediate value y₀′ 1021. Operand a₀ 1011 and inverted operands b₀′ 1017 and c₀′ 1019 are inputs to NAND gate 1022, resulting in an output 1023. Operand b₀ 1012 and inverted operands a₀′ 1015 and c₀′ 1019 are inputs to NAND gate 1024, resulting in an output 1025. Operand c₀ 1013 and inverted operands a₀′ 1015 and b₀′ 1017 are inputs to NAND gate 1026, resulting in an output 1027. Outputs 1021, 1023, 1025 and 1027 are inputs to NAND gate 1028, resulting in a sum bit s₀ 100. As may be seen, the gate delay of block 1010 is 2.

With respect to the second pre-processing block 1030, the initial propagation variable p_{0,i} 1034 and initial generation variables g_{0,i} 1035 may be derived. By applying double complementation, followed by DeMorgan's laws to Equation (28), an alternate formulation of the carry bit rᵢ may be derived using conjunction operations in the form of NAND gates:

rᵢ=aᵢ*bᵢ+aᵢ*cᵢ+bᵢ*cᵢ, (28)

rᵢ=(((aᵢ*bᵢ)+(aᵢ*cᵢ)+(bᵢ*cᵢ))′)′, (44)

rᵢ=((aᵢ*bᵢ)′*(aᵢ*cᵢ)′*(bᵢ*cᵢ)′)′. (45)

Second, from Equation (30), by applying double complementation, followed by DeMorgan's laws, an alternate formulation of the intermediate value xᵢ₊₁ may be derived using conjunction operations in the form of NAND gates:

xᵢ₊₁=aᵢ₊₁*bᵢ₊₁′*cᵢ₊₁′+aᵢ₊₁′*bᵢ₊₁*cᵢ₊₁′+aᵢ₊₁′*bᵢ₊₁′*cᵢ₊₁ (46)

xᵢ₊₁=(((aᵢ₊₁*bᵢ₊₁′*cᵢ₊₁′)+(aᵢ₊₁′*bᵢ₊₁*cᵢ₊₁′)+(aᵢ₊₁′*bᵢ₊₁′*cᵢ₊₁))′)′, (47)

xᵢ₊₁=((aᵢ₊₁*bᵢ₊₁′*cᵢ₊₁′)′*(aᵢ₊₁′*bᵢ₊₁′*cᵢ₊₁′)′*(aᵢ₊₁′*bᵢ₊₁′*cᵢ₊₁)′)′. (48)

Third, from Equation (35), by applying double complementation, followed by DeMorgan's laws, an alternate formulation of the i^{th} propagation variable p_{0,i} 1034 may be derived using conjunction operations in the form of NAND gates:

p_{0,i}=xᵢ₊₁′*yᵢ₊₁′*rᵢ+xᵢ₊₁*rᵢ′+yᵢ₊₁*rᵢ′, (35)

p_{0,i}=(((xᵢ₊₁′*yᵢ₊₁′*rᵢ)+(xᵢ₊₁*rᵢ′)+(yᵢ₊₁*rᵢ′))′)′, (49)

p_{0,i}=((xᵢ′₊₁*yᵢ₊₁′*rᵢ)′*(xᵢ₊₁*rᵢ′)′*(yᵢ₊₁*rᵢ′)′)′. (50)

Fourth and finally, from Equation (37), by applying double complementation, followed by DeMorgan's laws, an alternate formulation of the i^{th} generation variable g_{0,i} 1035 may be derived using conjunction operations in the form of NAND gates:

g_{0,i}=xᵢ₊₁*rᵢ+yᵢ₊₁*rᵢ, (37)

g_{0,i}=(((xᵢ₊₁*rᵢ)+(yᵢ₊₁*rᵢ))′)′, (51)

g_{0,i}=((xᵢ₊₁*rᵢ)′*(yᵢ₊₁*rᵢ)′)′. (52)

FIG. 10D shows the second pre-processing block 1030 in greater detail. It implements Equations (31), (46), (48) (50) and (52) and comprises six inverters 1039, 1041, 1043, 1053, 1057, 1067, one AND gate 1055 and fifteen NAND gates 1045, 1047, 1049, 1051, 1059, 1061, 1063, 1065, 1069, 1071, 1073, 1075, 1076, 1078, 1080 to generate the i^{th} initial propagation variable p_{0,i} 1034 and the i^{th} initial generation variable g_{0,i} 1035. Operands aᵢ 1031 and bᵢ 1032 are inputs to NAND gate 1045, resulting in an output 1046. Operands aᵢ 1031 and cᵢ 1033 are inputs to NAND gate 1047, resulting in an output 1048. Operands bᵢ 1032 and cᵢ 1033 are inputs to NAND gate 1049, resulting in an output 1050. Outputs 1046, 1048 and 1050 are inputs to NAND gate 1051, resulting in a carry bit rᵢ 67. Carry bit rᵢ 67 is an input to inverter 1053, resulting in an inverted carry bit rᵢ′ 1054.

Operand aᵢ₊₁ 1036 is an input to inverter 1039, resulting in an inverted operand aᵢ₊₁′ 1040. Operand bᵢ₊₁ 1037 is an input to inverter 1041, resulting in an inverted operand bᵢ₊₁′ 1042. Operand cᵢ₊₁ 1038 is an input to inverter 1043, resulting in an inverted operand cᵢ₊₁′ 1044.

Operands aᵢ₊₁ 1036, bᵢ₊₁ 1037 and cᵢ₊₁ 1038 are inputs to AND gate 1055, resulting in an intermediate value yᵢ 1056. Intermediate value yᵢ 1056 is an input to inverter 1057, resulting in an inverted intermediate value yᵢ′ 1058.

Operand aᵢ₊₁ 1036 and inverted operands bᵢ₊₁′ 1042 and cᵢ₊₁′ 1044 are inputs to NAND gate 1059, resulting in an output 1060. Operand bᵢ₊₁ 1037 and inverted operands aᵢ₊₁′ 1040 and cᵢ₊₁′ 1044 are inputs to NAND gate 1061, resulting in an output 1062. Operand cᵢ₊₁ 1038 and inverted operands aᵢ₊₁′ 1040 and bᵢ₊₁′ 1042 are inputs to NAND gate 1063, resulting in an output 1064. Outputs 1060, 1062 and 1064 are inputs to NAND gate 1065, resulting in an intermediate value xᵢ 1066. Intermediate value xᵢ 1066 is an input to inverter 1067, resulting in an inverted intermediate value xᵢ′ 1068.

Carry bit rᵢ 67 and inverted intermediate values yᵢ′ 1058 and xᵢ′ 1068 are inputs to NAND gate 1069, resulting in an output 1070. Inverted carry bit rᵢ′ 1054 and intermediate value yᵢ 1056 are inputs to NAND gate 1071, resulting in an output 1072. Inverted carry bit r_{i′} 1054 and intermediate value xᵢ 1066 are inputs to NAND gate 1073, resulting in an output 1074. Outputs 1070, 1072 and 1074 are inputs to NAND gate 1075, resulting in initial propagation variable p_{0,i} 1034, which occupies bit-position (i) of initial propagation vector P₀[0 . . . N−1] 951.

Carry bit rᵢ 67 and intermediate value yᵢ 1056 are inputs to NAND gate 1076, resulting in an output 1077. Carry bit rᵢ 67 and intermediate value xᵢ 1066 are outputs to NAND gate 1078, resulting in an output 1079. Outputs 1077 and 1079 are inputs to NAND gate 1080, resulting in initial generation variable g_{0,i} 1035, which occupies bit-position (i) of initial generation vector G₀[0 . . . N−1] 956.

As may be seen, the gate delay for block 1030 is 4.

With respect to the last pre-processing block 1085, since, as discussed above, the pre-processor 950 merges the generation of sum s and carry r bits normally performed by a 3:2 CSA with the generation of the initial propagation vector P₀[0 . . . N−1] 951 and the initial generation vector G₀[0 . . . N−1] 956, it follows that p_{0,N-1} is equal to r_{N-1}.

Accordingly, from Equation (28), we get:

rᵢ=aᵢ*bᵢ+aᵢ*cᵢ+bᵢ*cᵢ, (28)

[symbol]

p_{0,N-1}=a_{N-1}*b_{N-1}+a_{N-1}*c_{N-1}+b_{N-1}*c_{N-1}, (53)

p_{0,N-1}=((a_{N-1}*b_{N-1})′*(a_{N-1}*c_{N-1})′*(b_{N-1}*c_{N-1})′)′. (54)

FIG. 10E shows the last pre-processing block 1085 in greater detail. It implements Equation (54) and comprises four NAND gates 1091, 1093, 1095, 1097 to generate the (N−1)^{st} initial propagation variable p_{0,N-1} 1089. Operands a_{N-1} 1086 and b_{N-1} 1087 are inputs to NAND gate 1091, resulting in an output 1092. Operands a_{N-1} 1086 and c_{N-1} 1088 are inputs to NAND gate 1093, resulting in an output 1094. Operands b_{N-1} 1087 and c_{N-1} 1088 are inputs to NAND gate 1095, resulting in an output 1096. Outputs 1092, 1094 and 1096 are inputs to NAND gate 1097, resulting in initial propagation variable p_{0.N-1} 1089, which occupies the MSB of initial propagation vector P₀[0 . . . N−1] 951. The MSB of initial generation vector G₀[0 . . . N−1] 956 is, as discussed above, unused and set to 0. As may be seen, the gate delay for block 1085 is 2.

Turning now to FIG. 12A, there is shown a schematic view of an example embodiment of the generator 960. The generator 960 comprises an array of log₂(N)−1×N prefix circuits 1200, where i is an index that refers the to i^{th} column that takes on a value from 0 . . . N−1 and j is an index that refers to the j^{th} row that takes on a value from 1 . . . log₂(N)−1.

The first row of N prefix circuits 1200 each accept as input, the initial propagation p_{0,i} 1034 and initial generation g_{0,i} 1035 variables for the corresponding bit-position (i) and the initial propagation p_{0,i-1} 1034 and initial generation g_{0,i-1} 1035 variables for PSB bit-position (i−1) of the initial propagation vector P₀[0 . . . N−1] 951 and the initial generation vector G₀[0 . . . N−1] 956, and generate a set of composite propagation and generation variables, which are fed to the next row of prefix circuits 1200. The final row of prefix circuits 1200 generates composite propagation variables that occupy corresponding bit-positions of the N-bit composite propagation vector P_{log 2(N)-1}[0 . . . N−1] 961 and composite generation variables that occupy corresponding bit-positions of the N-bit composite generation vector G_{log 2(N)-1}[0 . . . N−1] 966.

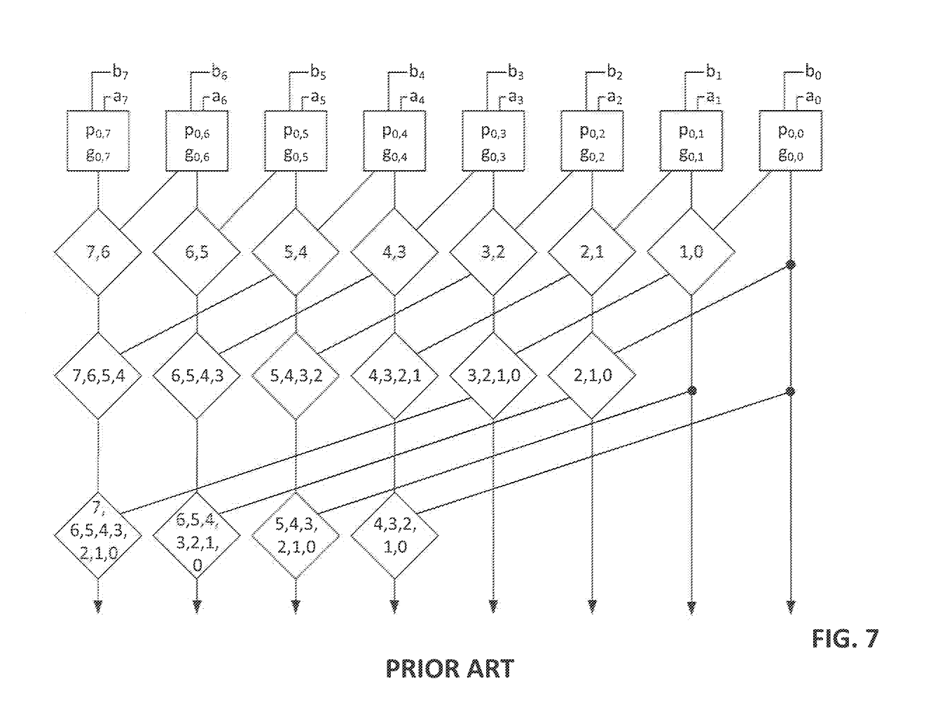

Each prefix circuit, denoted F(j,i) 1200, accepts as input, a pair of propagation and generation variables (p_{j,i}, g_{j,i}) where both pairs have a row coefficient of j and the first pair has a column coefficient of i and the second pair has a column coefficient of i−k. The first pair of variables are, in the case of row j=1, the corresponding bit-position (i) of the initial propagation vector P₀[0 . . . N−1] 951 and of the initial generation vector G₀[0 . . . N−1] 956, and in the case of j=2 . . . log₂(N)−1, the composite propagation and generation variables p_{j-1,i}, g_{j-1,i} output by the prefix circuit F(j−1,i) 1200 directly above it in row j−1, column i, while the second pair of variables are, in the case of j=1, the bit-position (i−k) k places to the right of the initial propagation vector P₀[0 . . . N−1] 951 and of the initial generation vector G₀[0 . . . N−1] 956, and in the case of j=2 . . . log₂(N)−1, the propagation and generation variables p_{j-1,i-k}, g_{j-1,i-k} output by a prefix circuit F(j−1,i−k) 1200 one row above in row j−1 and to the right k places in column i−k, where k is a constant that depends upon the sparsity of the prefix operation and the row level j. The sparsity refers to how many carry bits are generated by the carry-tree, such as in the example shown in FIG. 7. For an adder of sparsity 1 (in which every carry bit is generated, such as is shown in FIG. 7 by way of example only), as shown in Equations (14)-(17) herein, k=2^{j-1}.

The first propagation variable is thus p_{j-1,i} 1201 and the first generation variable is g_{j-1,i} 1202, while the second propagation variable is p_{j-1,i-k} 1203 and the second generation variable is g_{j-1,i-k} 1204. These first and second propagation variables p_{j-1,i} 1201, p_{j-1,i-k} 1203 and the first and second generation variables g_{j-1,i} 1202, g_{j-1,i-k} 1204 may be, in the case of j=1, bit-positions of the initial propagation vector P₀[0 . . . N−1] 951 and of the initial generation vector G₀[0 . . . N−1] 956, and in the case of j=2 . . . log₂(N)−1, composite propagation variables output by prefix circuits F(j−1,i) 1200 and F(j−1,i−k) 1200.

The prefix circuit F(j,i) 1200 outputs a pair of propagation and generation variables (p_{j,i}, g_{j,i}) having a row coefficient of j and a column coefficient of i.

In accordance with Equations (14)-(17), for each row in the range j=1 . . . log₂(N)−1, prefix circuits 1200 may be one of two types, depending upon the value of the circuit's row j and column i.

FIG. 12B shows a prefix circuit 1200a suitable for use for values of j=1 . . . log₂(N)−1 and corresponding columns i=0 . . . 2^{j-1}−1 in greater detail. It implements Equations (14) and (15) to generate composite generation variable g_{j,i} 1208. In prefix circuit 1200a, inputs p_{j-1,i} 1201, p_{j-1,i-k} 1203 and g_{j-1,i-k} 1204 are ignored. Input g_{j-1,i} 1202 is directly connected to output composite generation variable g_{j,i} 1208. Output composite propagation variable p_{j,i} 1210 is set to 0, such as by zero-generator 1211.

FIG. 12C shows a prefix circuit 1200b suitable for use for values of j=1 . . . log₂(N)−1 and corresponding columns i=2^{j-1} . . . N−1 in greater detail. It implements Equations (16) and (17) and comprises two AND gates 1205, 1208 and an OR gate 1207 to generate composite propagation variable p_{j,i} 1210 and composite generation variable g_{j,i} 1208. The first propagation variable p_{j-1,i} 1201 and the second generation variable g_{j-1,i-k} 1204 are inputs to AND gate 1205, resulting in an output 1206. The first propagation variable p_{j-1,i} 1201 and the second propagation variable p_{j-1,i-k} 1203 are inputs to AND gate 1208, resulting in the output composite propagation variable p_{j,i} 1210. The first generation variable g_{j-1,i} 1202 and the output 1206 are inputs to an OR gate 1207, resulting in the output composite generation variable g_{j,i} 1208.

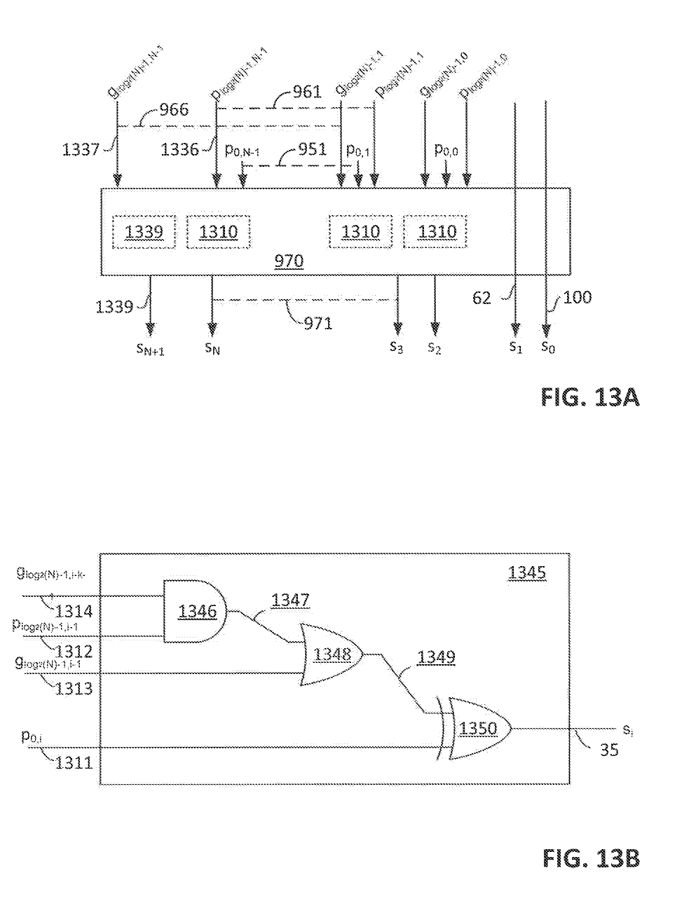

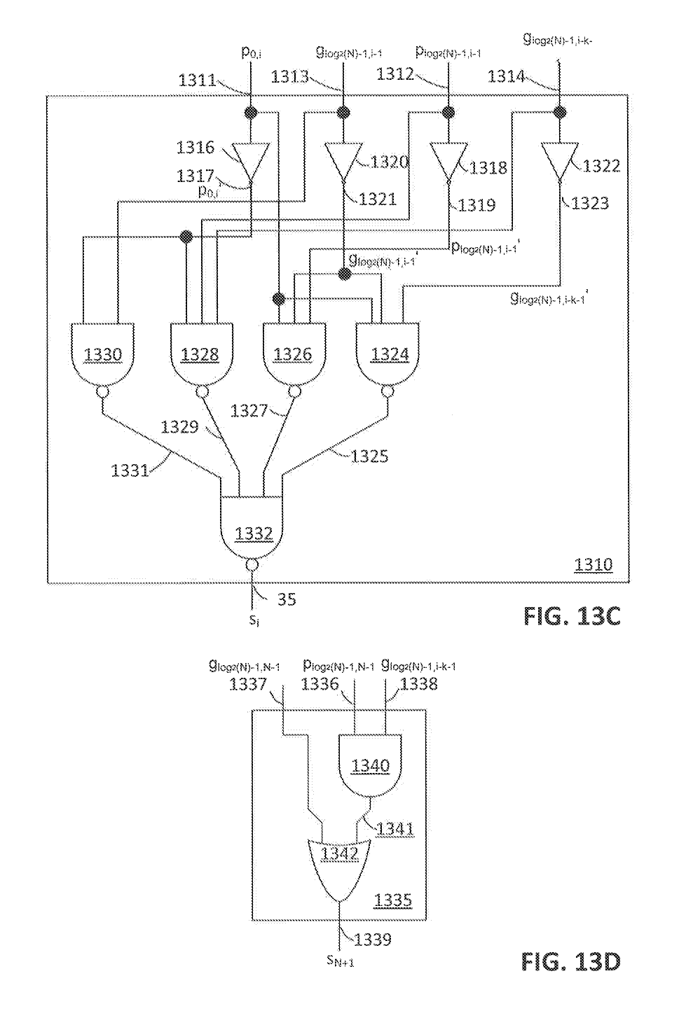

Turning now to FIG. 13A, there is shown a schematic view of an example embodiment of the post-processor 970. The post-processor 970 comprises N post-processing blocks 1310, 1335. The last post-processing block 1335 accepts as inputs the MSB of the composite propagation vector P_{log 2(N)-1}[0 . . . N−1] 961, namely p_{log 2(N)-1,N-1} 1336, and the MSB and another bit-position of the composite generation vector G_{log 2(N)-1}[0 . . . N−1] 966, namely g_{log 2(N)-1,N-1} 1337 and g_{log 2(N)-1,N-k-1} 1338, and generates a single sum bit, namely s_{N+1} 1339. The corresponding bit-position of the composite propagation vector P_{log 2(N)-1}[0 . . . N−1], namely p_{log 2(N)-1,N-k-1} (not shown) is not used.

The remaining post-processing blocks 1310 each accept as inputs bit-position (i) of the initial propagation vector P₀[0 . . . N−1] 951, namely p_{0,i} 1311, bit-position (i−1) of the composite propagation vector P_{log 2(N)-1}[0 . . . N−1] 961, namely p_{log 2(N)-1,i-1} 1312, and bit-position (i−1) of the composite generation vector G_{log 2(N)-1}[0 . . . N−1] 966, namely g_{log 2(N)-1,i-1} 1313 and bit-position (i−k−1) thereof, namely g_{log 2(N)-1,i-k-1} 1314 and generates a single sum bit, namely sᵢ 35.

Thus the adder 900 moves the parallel prefix operation for the row j=log₂ N, which would notionally obtain the final composite propagation vector P_{log 2(N)}[0 . . . N−1] and the composite generation vector G_{log 2(N)}[0 . . . N−1] from the penultimate composite propagation vector P_{log 2(N)-1}[0 . . . N−1] 961, from the generator 960, where a conventional KS adder would typically perform such operation, to the post-processor 970. At the same time, the post-processor 970 uses the information contained in corresponding bit-positions of the penultimate composite propagation vector P_{log 2(N)-1}[0 . . . N−1] 961, together with corresponding bit-positions of the initial propagation vector P₀[0 . . . N−1] 951, which, according to Equation (19), is conventionally XORed with the composite generation vector G_{log 2(N)}[0 . . . N−1] 966 to arrive at the sum bits S[2 . . . N+1]. In so doing, the calculation of the final composite propagation vector P_{log 2(N)}[0 . . . N−1] and the composite generation vector G_{log 2(N)}[0 . . . N−1] is obviated.

It may be shown from Equations (8) and (9) that the bit-position of the sum S[2 . . . N] 940 may be defined as:

sᵢ=p_{0,i} ⊕ (p_{log 2(N)-1,i-1}*g_{log 2(N)-1,i-1}+g_{log 2(N)-1,i-k-1}), for i=2 . . . N (55)

FIG. 13B shows an example digital circuit that implements the relationships of Equation (55) The circuit, shown generally at 1345, comprises an AND gate 1346, an OR gate 1348 and an XOR gate 1350, accepts as inputs initial propagation variable p_{o,l} 1311, composite propagation variable p_{log 2(N)-1,i-1} 1312, composite generation variable g_{log 2(N)-1,i-k-1} 1314, and composite generation variable g_{log 2(N)-1,i-1} 1313 and outputs sum bit sᵢ 35. Composite propagation variable p_{log 2(N)-1,i-1} 1312 and composite generation variable g_{log 2(N)-1,i-k-1} 1314 are inputs to AND gate 1346, resulting in output 1347. Composite generation variable g_{log 2(N)-1,i-1} 1313 and output 1347 are inputs to OR gate 1348, resulting in output 1349. Initial propagation variable p_{0,i} 1311 and output 1349 are inputs to XOR gate 1350, resulting in sum bit sᵢ 35.

FIG. 13C shows the post-processing blocks 1310 in greater detail. It implements Equation (55) and comprise four inverters 1316, 1318, 1320, 1322 and five NAND gates 1324, 1326, 1328, 1330, 1332 to generate the output sum bits sᵢ, i=2 . . . N 35, recognizing that s₀ 100 and s₁ 62 are generated by the pre-processor 950. Initial propagation variable p_{0,i} 1311 is an input to inverter 1316, resulting in an inverted initial propagation variable p_{0,i}′ 1317. Composite propagation variable p_{log 2(N)-1,i-1} 1312 is an input to inverter 1318, resulting in an inverted composite propagation variable p_{log 2(N)-1,i-1}′ 1319. Composite generation variable g_{log 2(N)-1,i-1} 1313 is an input to inverter 1320, resulting in an inverted composite generation variable g_{log 2(N)-1,i-1}′ 1321. Composite generation variable g_{log 2(N)-1,i-k-1} 1314 is an input to inverter 1322, resulting in an inverted composite generation variable g_{log 2(N)-1,i-k-1}′ 1323.

Initial propagation variable p_{0,i} 1311 and inverted composite generation variables g_{log 2(N)-1,i-1}′ 1321 and g_{log 2(N)-1,i-k-1}′ 1323 are inputs to NAND gate 1324, resulting in an output 1325. Initial propagation variable p_{0,i} 1311 and inverted composite propagation variable p_{log 2(N)-1 ,i-1}′ 1319 and inverted composite generation variable g_{log 2(N)-1,i-1}′ 1321 are inputs to NAND gate 1326, resulting in an output 1327. Composite propagation variable p_{log 2(N)-1,i-1} 1312 and composite generation variable g_{log 2(N)-1,i-k-1} 1314 and inverted initial propagation variable p_{0,i}′ 1317 are inputs to NAND gate 1328, resulting in an output 1329. Composite generation variable g_{log 2(N)-1,i-1} 1313 and inverted initial propagation variable p_{0,i}′ 1317 are inputs to NAND gate 1330, resulting in an output 1331. Outputs 1325, 1327, 1329 and 1331 are inputs to NAND gate 1332, resulting in sum bit sᵢ 35.

It may also be shown from Equations (8) and (9), that the MSB bit-position (N+1) of the sum S[0 . . . N+1] 940 may be defined as:

s_{N+1}=g_{log 2(N)-1,N}=g_{log 2(N),N-1}+p_{log 2(N)-1,N-1}*g_{log 2(N)-1,N-k-1}, (56)

FIG. 13D shows the post-processing block 1335 in greater detail. It implements Equation (56) and comprises an AND gate 1340 and an OR gate 1342 to generate the output MSB sum bit s_{N+1} 1339. Composite propagation variable p_{log 2(N)-1,N-1} 1336 and composite generation variable g_{log 2(N)-1,N-k-1} 1338 are inputs to AND gate 1340, resulting in an output 1341. Composite generation variable g_{log 2(N)-1,N-1} 1337 and output 1341 are inputs to OR gate 1342, resulting in sum bit s_{N+1} 1339.

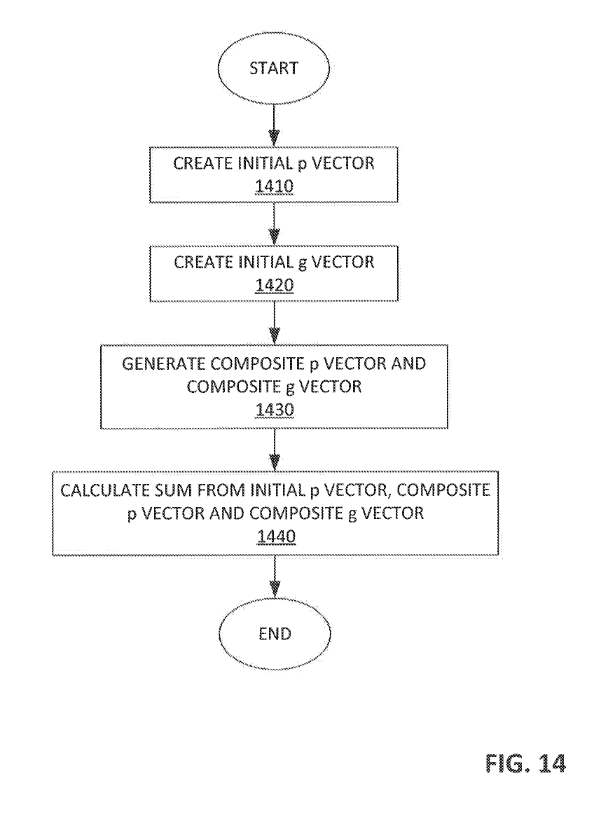

Turning now to FIG. 14, there is shown a flow chart showing example actions that may be taken in a method for calculating a sum of three input operands.

An action 1410 comprises creating an initial propagation vector P₀[0 . . . N−1] 951 having a plurality of bit-positions, each bit-position in the plurality representing whether a carry-in bit is propagated as a carry-out bit, from respective bit-positions of each of the three input operands. Action 1410 may be performed by the pre-processor 950.

An action 1420 comprises creating an initial generation vector G₀[0 . . . N−1] 956 having a plurality of bit-positions, each bit-position in the plurality representing whether the carry-out bit is generated, from respective bit-positions of each of the three input operands. Action 1420 may be performed by the pre-processor 950.

An action 1430 comprises generating a composite propagation vector P_{log 2(N)-1}[0 . . . N−1] 961 and a composite generation vector G_{log 2(N)-1}[0 . . . N−1] 966 from parallel prefix actions on the initial propagation vector P₀[0 . . . N−1] 951 and the initial generation vector G₀[0 . . . N−2] 956. Action 1430 may be performed by the generator 960.

An action 1440 comprises calculating the sum from the initial propagation vector P₀[0 . . . N−1] 951, composite propagation vector P_{log 2(N)-1}[0 . . . N−1] 961 and the composite generation vector G_{log 2(N)-1}[0 . . . N−1] 966. Action 1440 may be performed by the post-processor 970.

Having described in detail example embodiments that are in accordance with the present disclosure, it is noted that the embodiments reside primarily in combinations of apparatus components and processing actions related to interactions between complementary common-mode voltage devices, whether or not specifically identified as a transmitter and a receiver.

In some example embodiments, the adder may form part of a base station. In some example embodiments, the adder may form part of a mobile communications device. Although some embodiments may include mobile devices, not all embodiments are limited to mobile devices; rather, various embodiments may be implemented within a variety of communications devices or terminals, including handheld devices, mobile telephones, or personal digital assistants (PDAs).

Those having ordinary skill in this art will appreciate that conjunction operations may be performed by an AND gate or a NAND gate. Circuit fragments implemented as an AND gate may be implemented as a NAND gate with a subsequent inverter, or by selecting as an output an inverted version of the output thereof. Similarly, circuit fragments implemented as a NAND gate may be implemented as an AND gate with a subsequent inverter, or by selecting as an output an inverted version of the output thereof. Similarly, disjunction operations may be performed by an OR gate or a NOR gate. Circuit fragments implemented as an OR gate may be implemented as a NOR gate with a subsequent inverter, or by selecting as an output an inverted version of the output thereof. Similarly, circuit fragments implemented as a NOR gate may be implemented as an OR gate with a subsequent inverter, or by selected as an output an inverted version of the output thereof.

Further, those having ordinary skill in this art will appreciated that by application of DeMorgan's laws, a conjunction operation such as may be performed by an AND gate or NAND gate may be converted to a disjunction operation such as may be performed by an OR gate or NOR gate by inverting the inputs thereof and the output thereof, whether or not by implementing a discrete inverter. Similarly, a disjunction operation such as may be performed by an OR gate or NOR gate may be converted to a conjunction operation such as may be performed by an AND gate or NAND gate by inverting the inputs thereof and the output thereof, whether or not by implementing a discrete inverter

Those having ordinary skill in this art will appreciate the number of inputs to an AND, OR, NAND or NOR gate may be increased or decreased, thus decreasing or increasing the number of parallel gates used. Further, an output, whether or not inverted, of an AND, OR, NAND or NOR gate may be supplemented by a second output which is an inverted or non-inverted version thereof, thus dispensing with a discrete inverter. Still further, a plurality of similar gates may be combined in a single circuit element.

The present disclosure can be implemented in digital electronic circuitry, or in computer hardware, firmware, software, or in combination thereof. Apparatus of the disclosure can be implemented in a computer program product tangibly embodied in a machine-readable storage device for execution by a programmable processor; and method actions can be performed by a programmable processor executing a program of instructions to perform functions of the disclosure by operating on input data and generating output.

The disclosure can be implemented advantageously on a programmable system including at least one input device, and at least one output device.

Moreover, explicit use of the term “module”, “processor” or “controller” should not be construed to refer exclusively to a particular configuration of hardware.

In some instances, detailed descriptions of well-known devices, circuits and methods are omitted so as not to obscure the description of the present disclosure with unnecessary detail.

In the foregoing disclosure, for purposes of explanation and not limitation, specific details are set forth in order to provide a thorough understanding of the present disclosure.

Accordingly, the system and method components have been represented where appropriate by conventional symbols in the drawings, showing only those specific details that are pertinent to understanding the embodiments of the present disclosure, so as not to obscure the disclosure with details that will be readily apparent to those of ordinary skill in the art having the benefit of the description herein.

Any feature or action shown in dashed outline may in some example embodiments be considered as optional.

Certain terms are used throughout to refer to particular components. Manufacturers may refer to a component by different names. Use of a particular term or name is not intended to distinguish between components that differ in name but not in function.

The terms “including” and “comprising” are used in an open-ended fashion, and thus should be interpreted to mean “including, but not limited to”. The terms “example” and “exemplary” are used simply to identify instances for illustrative purposes and should not be interpreted as limiting the scope of the invention to the stated instances. In particular, the term “exemplary” should not be interpreted to denote or confer any laudatory, beneficial or other quality to the expression with which it is used, whether in terms of design, performance or otherwise.

The terms “couple” and “communicate” in any form are intended to mean either a direct connection or indirect connection through some interface, device, intermediate component or connection, whether electrically, mechanically, chemically, or otherwise.

Directional terms such as “upward”, “downward”, “left” and “right” are used to refer to directions in the drawings to which reference is made unless otherwise stated. Similarly, words such as “inward” and “outward” are used to refer to directions toward and away from, respectively, the geometric center of the device, area or volume or designated parts thereof. Moreover, all dimensions described herein are intended solely to be by way of example for purposes of illustrating certain embodiments and are not intended to limit the scope of the disclosure to any embodiments that may depart from such dimensions as may be specified.

References in the singular form include the plural and vice versa, unless otherwise noted.

As used herein, relational terms, such as “first” and “second”, and numbering devices such as “a”, “b” and the like, may be used solely to distinguish one entity or element from another entity or element, without necessarily requiring or implying any physical or logical relationship or order between such entities or elements.

Some or some part(s) of the embodiments described above may be expressed in clauses set out in the following manner:

An adder for calculating a sum of three input operands, comprising: a pre-processor, for creating: an initial propagation vector having a plurality of bit-positions, each bit-position in the plurality representing whether a carry in bit is propagated as a carry out bit as determined from a value of respective bit-positions of each of the three operands; and an initial generation vector having a plurality of bit-positions, each bit-position in the plurality representing whether a carry out bit is generated as determined from a value of respective bit-positions of each of the three operands; a generator, for generating a composite propagation vector and a composite generation vector from parallel prefix operations on the initial propagation vector and initial generation vector; and a post-processor, for calculating corresponding sum bits from the initial propagation vector, the composite propagation vector and the composite generation vector.

An adder according to a previous clause, where each operand is a binary N-bit number and the sum is a binary N+2-bit number.

An adder according a previous clause, wherein the initial propagation vector, the initial generation vector, the composite propagation vector and the composite generation vector are N-bits in length.

An adder according to a previous clause, wherein the pre-processor comprises a first pre-processing block for creating a least significant bit-position (0) of the sum.

An adder according to a previous clause, wherein the pre-processor comprises a second pre-processing block for creating a corresponding bit-position of the initial propagation vector and of the initial generation vector for a bit-position other than the least significant bit-position (0) and a most significant bit-position (N−1).

An adder according to a previous clause, wherein the second pre-processing block for creating a least significant bit-position (0) of the initial propagation vector calculates a bit-position (1) of the sum that is immediately more significant than the least significant bit-position (0) of the sum.

An adder according to a previous clause, wherein the post-processor calculates only the bit-positions more significant than bit-positions (0) and (1) of the sum.

An adder according to a previous clause, wherein the second pre-processing block: creates a bit-position (i) of the initial propagation vector from an exclusive-OR of a corresponding bit-position (i) of each of the operands; and creates a bit-position (i) of the initial generation vector from an AND of a corresponding i^{th} bit-position of each of the operands.

An adder according to a previous clause, wherein the second pre-processing block creates: a first intermediate value comprising a NAND of three first products, each first product comprising a NAND of a corresponding bit-position (i+1) of a first one of the operands and inverses of a corresponding bit-position (i+1) of remaining ones of the operands, each first product having a different one of the operands as the first one of the operands; and a second intermediate value from an AND of a corresponding bit-position of each of the operands.

An adder according to a previous clause, wherein the second pre-processing block creates a carry bit comprising a NAND of three second products, each second product comprising a NAND of a corresponding bit-position (i) of a first one and a second one of the operands, each second product having a different first one of the operands and a different second one of the operands, the first one of the operands being different from the second one of the operands in each second product.

An adder according to a previous clause, wherein the second pre-processing block creates the bit-position (i) other than a most significant bit-position (N−1) of the initial propagation vector from a NAND of: a first NAND of the carry bit, an inverse of the second intermediate value and an inverse of the first intermediate value; a second NAND of an inverse of the carry bit and the first intermediate value; and a third NAND of the inverse of the carry bit and the second intermediate value.

An adder according to a previous clause, wherein the second pre-processing block creates the bit-position (i) other than a most significant bit-position (N−1) of the initial generation vector from a NAND of: a first NAND of the carry bit and the first intermediate value; and a second NAND of the carry bit and the second intermediate value.

An adder according to a previous clause, wherein the pre-processor comprises a third pre-processing block that creates a most significant bit-position (N−1) of the initial propagation vector as a NAND of three second products, each second product comprising a NAND of a corresponding most significant bit-position of a first one and a second one of the operands, each second product having a different first one of the operands and a different second one of the operands, the first one of the operands being different from the second one of the operands in each second product.

An adder according to a previous clause, wherein the third pre-processing block sets a most significant bit-position (N−1) of the initial generation vector to 0.

An adder according to a previous clause, wherein the generator comprises an array of processing circuits.

An adder according to a previous clause, wherein the array is sparse.

An adder according to a previous clause, wherein the array has n rows of N processing circuits, where n=log₂(N)−1.

An adder according to a previous clause, wherein a processing circuit at row j and column i accepts first and second propagation variables and first and second generation variables and generates a third propagation variable and a third generation variable.

An adder according to a previous clause, wherein j is 0 and wherein: the first propagation variable is a bit-position (i) of the initial propagation vector; the second propagation variable is a bit position (i−k) of the initial propagation vector; the first generation variable is a bit-position (i) of the initial generation vector; and the second generation variable is a bit position (i−k) of the initial generation vector.

An adder according to a previous clause, wherein, when j exceeds 0: the first propagation variable is the third propagation variable of a processing circuit at row j−1 and column i; the second propagation variable is the third propagation variable of a processing circuit at row j−1 and column i−k; the first generation variable is the third generation variable of a processing circuit at row j−1 and column i; and the second generation variable is the third generation variable of a processing circuit at row j−1 and column i−k.

An adder according to a previous clause, wherein the third propagation variable is an AND of the first propagation variable and the second propagation variable.

An adder according to a previous clause, wherein the third generation variable is an OR of the first generation variable with an AND of the first propagation variable and the second generation variable.

An adder according to a previous clause, wherein the post-processor comprises a first post-processing block for calculating a most significant bit-position (N+1) of the sum.

An adder according to a previous clause, wherein the first post-processing block calculates the most significant bit-position (N+1) of the sum from an OR of a most significant bit-position (N−1) of the composite generation vector with an AND of a most significant bit-position (N−1) of the composite propagation vector and a bit-position (N−k−1) of the composite generation vector.

An adder according to a previous clause, wherein the post-processor comprises a second post-processing block each for calculating a corresponding bit-position of the sum other than the most significant bit-position (N+1), a least significant bit-position (0) and a bit-position (1) of the sum that is immediately more significant than the least significant bit-position (0) of the sum.

An adder according to a previous clause, wherein the second post-processing block corresponding to a bit-position (i) of the sum creates the bit-position (i) of the sum from a NAND of: a first NAND of the bit-position (i) of the initial propagation vector, an inverse of a bit-position (i−1) of the composite propagation vector and an inverse of a bit-position (i−1) of the composite generation vector; a second NAND of the bit-position (i) of the initial propagation vector, the inverse of the bit-position (i−1) of the composite generation vector and an inverse of a bit-position (i−k−1) of the composite generation vector; a third NAND of an inverse of the bit-position (i) of the initial propagation vector and the bit-position (i−1) of the composite generation vector; and a fourth NAND of the inverse of the bit-position (i) of the initial propagation vector, the bit-position (i−1) of the composite propagation vector and the bit-position (i−k−1) of the composite generation vector.

An adder according to a previous clause having a gate delay of 2 log₂(N)+4.

A method for calculating a sum of three input operands, comprising actions of: creating an initial propagation vector having a plurality of bit-positions, each bit-position in the plurality representing whether a carry in bit is propagated as a carry out bit as determined from a value of respective bit-positions of each of the three operands; creating an initial generation vector having a plurality of bit-positions, each bit-position in the plurality representing whether a carry out bit is generated as determined from a value of respective bit-positions of each of the three operands; generating a composite propagation vector and a composite generation vector from parallel prefix actions on the initial propagation vector and the initial generation vector; and calculating the sum from the initial propagation vector, the composite propagation vector and the composite generation vector.

An adder for calculating a sum of three input operands, comprising: a pre-processor, for creating: an initial propagation vector having a plurality of bit-positions, each bit-position in the plurality representing whether a carry-in bit is propagated as a carry-out bit as determined from a value of respective bit-positions of each of the three operands; and an initial generation vector having a plurality of bit-positions, each bit-position in the plurality representing whether a carry-out bit is generated as determined from a value of respective bit-positions of each of the three operands; a generator, for generating a composite propagation vector and a composite generation vector from parallel prefix operations on the initial propagation vector and initial generation vector; and a post-processor, for calculating corresponding sum bits from the initial propagation vector, the composite propagation vector and composite generation vector.

An adder according to a previous clause, where each operand is a binary number of no more than N bits and the sum is a binary number of no more than N+2 bits.

An adder according a previous clause, wherein the initial propagation vector, the initial generation vector, the composite propagation vector and the composite generation vector are a maximum of N bits in length.

An adder according to a previous clause, wherein the pre-processor comprises a pre-processing block for creating a least significant bit-position (0) of the sum.

An adder according to a previous clause, wherein the pre-processing block creates: a first intermediate value comprising a first operation on three first products, each first product comprising an output of a second operation on a corresponding bit-position (l+1) of a first one of the operands and inverses of a corresponding bit-position (i+1) of remaining ones of the operands, each first product having a different one of the operands as the first one of the operands; and a second intermediate value from a third operation on a corresponding bit-position (i+1) of each of the operands.

An adder according to a previous clause, wherein the first operation is a conjunction operation.

An adder according to a previous clause, wherein the conjunction operation is a NAND operation.

An adder according to a previous clause, wherein the second operation is a conjunction operation.

An adder according to a previous clause, wherein the conjunction operation is a NAND operation.

An adder according to a previous clause, wherein the third operation is a conjunction operation.

An adder according to a previous clause, wherein the conjunction operation is a NAND operation.

An adder according to a previous clause, wherein the pre-processor comprises a pre-processing block for creating a corresponding bit-position of the initial propagation vector and of the initial generation vector for a bit-position other than the least significant bit-position (0) and a most significant bit-position (N−1).

An adder according to a previous clause, wherein the pre-processing block for creating a least significant bit-position (0) of the initial propagation vector calculates a bit-position (1) of the sum that is immediately more significant than the least significant bit-position (0) of the sum.

An adder according to a previous clause, wherein the post-processor calculates the bit-positions more significant than bit-positions (0) and (1) of the sum.

An adder according to a previous clause wherein the pre-processing block creates: a first intermediate value comprising a first operation on three first products, each first product comprising an output of a second operation on a corresponding bit-position (l+1) of a first one of the operands and inverses of a corresponding bit-position (i+1) of remaining ones of the operands, each first product having a different one of the operands as the first one of the operands; and a second intermediate value from a third operation on a corresponding bit-position (i+1) of each of the operands.

An adder according to a previous clause, wherein the first operation is a conjunction operation.

An adder according to a previous clause, wherein the conjunction operation is performed by a NAND gate.

An adder according to a previous clause, wherein the second operation is a conjunction operation.

An adder according to a previous clause, wherein the conjunction operation is performed by a NAND gate.

An adder according to a previous clause, wherein the third operation is a conjunction operation.

An adder according to a previous clause, wherein the conjunction operation is performed by a NAND gate.

An adder according to a previous clause, wherein the pre-processing block creates a carry bit comprising a first operation on three second products, each second product comprising a pair-wise second operation on a corresponding bit-position (i) of a first one and a second different one of the operands.

An adder according to a previous clause, wherein the first operation is a conjunction operation.

An adder according to a previous clause, wherein the conjunction operation is performed by a NAND gate.

An adder according to a previous clause, wherein the second operation is a conjunction operation.

An adder according to a previous clause, wherein the conjunction operation is performed by a NAND gate.

An adder according to a previous clause, wherein the pre-processing block creates the bit-position (i) other than a most significant bit-position (N−1) of the initial propagation vector from a first operation on outputs of: a second operation on the carry bit, an inverse of the second intermediate value and an inverse of the first intermediate value; a third operation on an inverse of the carry bit and the first intermediate value; and a fourth operation on the inverse of the carry bit and the second intermediate value.

An adder according to a previous clause, wherein the first operation is a conjunction operation.

An adder according to a previous clause, wherein the conjunction operation is performed by a NAND gate.

An adder according to a previous clause, wherein the second operation is a conjunction operation.

An adder according to a previous clause, wherein the conjunction operation is performed by a NAND gate.

An adder according to a previous clause, wherein the third operation is a conjunction operation.

An adder according to a previous clause, wherein the conjunction operation is performed by a NAND gate.

An adder according to a previous clause, wherein the fourth operation is a conjunction operation.

An adder according to a previous clause, wherein the conjunction operation is performed by a NAND gate.

An adder according to a previous clause, wherein the pre-processing block creates the bit-position (i) other than a most significant bit-position (N−1) of the initial generation vector from a first operation on outputs of: a second operation on the carry bit and the first intermediate value; and a third operation on the carry bit and the second intermediate value.

An adder according to a previous clause, wherein the first operation is a conjunction operation.

An adder according to a previous clause, wherein the conjunction operation is performed by a NAND gate.

An adder according to a previous clause, wherein the second operation is a conjunction operation.

An adder according to a previous clause, wherein the conjunction operation is performed by a NAND gate.

An adder according to a previous clause, wherein the third operation is a conjunction operation.

An adder according to a previous clause, wherein the conjunction operation is performed by a NAND gate.

An adder according to a previous clause, wherein the pre-processor comprises a pre-processing block for creating a most significant bit-position (N−1) of the initial propagation vector.

An adder according to a previous clause, wherein the pre-processing block creates the most significant bit-position (N−1) of the initial propagation vector as a first operation on three second products, each second product comprising an output of a second operation on a corresponding most significant bit-position of a first one and a second one of the operands, each second product having a different first one of the operands and a different second one of the operands, the first one of the operands being different from the second one of the operands in each second product.

An adder according to a previous clause, wherein the first operation is conjunction operation.

An adder according to a previous clause, wherein the conjunction operation is performed by a NAND gate.

An adder according to a previous clause, wherein the second operation is conjunction operation.

An adder according to a previous clause, wherein the conjunction operation is performed by a NAND gate.

An adder according to a previous clause, wherein the pre-processing block sets a most significant bit-position (N−1) of the initial generation vector to 0.

An adder according to a previous clause, wherein the generator comprises an array of processing circuits.

An adder according to a previous clause, where the array is sparse.

An adder according to a previous clause, wherein the array has log₂(N)−1 rows of N processing circuits.

An adder according to a previous clause, where a processing circuit at row j and column i accepts first and second propagation variables and first and second generation variables and generates a third propagation variable and a third generation variable.

An adder according to a previous clause, wherein, when j is 0: the first propagation variable is a bit-position (i) of the initial propagation vector; the second propagation variable is a bit position (i−k) of the initial propagation vector; the first generation variable is a bit-position (i) of the initial generation vector; and the second generation variable is a bit position (i−k) of the initial generation vector.

An adder according to a previous clause, wherein, when j exceeds 0: the first propagation variable is the a propagation variable generated by a processing circuit at row j−1 and column i; the second propagation variable is a propagation variable generated by a processing circuit at row j−1 and column i−k; the first generation variable is a generation variable generated by a processing circuit at row j−1 and column i; and the second generation variable is a generation variable generated by a processing circuit at row j−1 and column i−k.

An adder according to a previous clause wherein the third propagation variable is an operation on the first propagation variable and the second propagation variable.

An adder according to a previous clause, wherein the operation is a conjunction operation.

An adder according to a previous clause, wherein the conjunction operation is performed by an AND gate.

An adder according to a previous clause, wherein the third generation variable is a first operation on the first generation variable and an output of a second operation on the first propagation variable and the second generation variable.

An adder according to a previous clause, wherein the first operation is a disjunction operation.

An adder according to a previous clause, wherein the disjunction operation is performed by an OR gate.

An adder according to a previous clause, wherein the second operation is a conjunction operation.

An adder according to a previous clause, wherein the conjunction operation is performed by an AND gate.

An adder according to a previous clause, wherein the post-processor comprises a post-processing block for calculating a most significant bit-position (N+1) of the sum.

An adder according to a previous clause, wherein the post-processing block calculates the most significant bit-position (N+1) of the sum from a first operation on a most significant bit-position (N−1) of the composite generation vector and an output of a second operation a most significant bit-position (N−1) of the composite propagation vector and a bit-position (N−k−1) of the composite generation vector.

An adder according to a previous clause, wherein the first operation is a disjunction operation.

An adder according to a previous clause, wherein the disjunction operation is performed by an OR gate.

An adder according to a previous clause, wherein the second operation is a conjunction operation.

An adder according to a previous clause, wherein the conjunction operation is performed by an AND gate.

An adder according to a previous clause, wherein the post-processor comprises a post-processing block for calculating a corresponding bit-position of the sum other than the most significant bit-position (N+1), a least significant bit-position (0) and a bit-position (1) of the sum that is immediately more significant than the least significant bit-position (0) of the sum.

An adder according to a previous clause, wherein the post-processing block corresponding to a bit-position (i) of the sum creates the bit-position (i) of the sum from a first operation on: an output of a second operation on the bit-position (i) of the initial propagation vector, an inverse of a bit-position (i−1) of the composite propagation vector and an inverse of a bit-position (i−1) of the composite generation vector; an output of a third operation on the bit-position (i) of the initial propagation vector, the inverse of the bit-position (i−1) of the composite generation vector and an inverse of a bit-position (i−k−1) of the composite generation vector; an output of a fourth operation on an inverse of the bit-position (i) of the initial propagation vector and the bit-position (i−1) of the composite generation vector; and an output of a fifth operation on the inverse of the bit-position (i) of the initial propagation vector, the bit-position (i−1) of the composite propagation vector and the bit-position (i−k−1) of the composite generation vector.

An adder according to a previous clause, wherein the first operation is a conjunction operation.

An adder according to a previous clause, wherein the conjunction operation is performed by a NAND gate.

An adder according to a previous clause, wherein the second operation is a conjunction operation.

An adder according to a previous clause, wherein the conjunction operation is performed by a NAND gate.

An adder according to a previous clause, wherein the third operation is a conjunction operation.

An adder according to a previous clause, wherein the conjunction operation is performed by a NAND gate.

An adder according to a previous clause, wherein the fourth operation is a conjunction operation.

An adder according to a previous clause, wherein the conjunction operation is performed by a NAND gate.

An adder according to a previous clause, wherein the fifth operation is a conjunction operation.

An adder according to a previous clause, wherein the conjunction operation is performed by a NAND gate.

A method for calculating a sum of three input operands, comprising actions of: creating an initial propagation vector having a plurality of bit-positions, each bit-position in the plurality representing whether a carry-in bit is propagated as a carry-out bit as determined from a value of respective bit-positions of each of the three operands; creating an initial generation vector having a plurality of bit-positions, each bit-position in the plurality representing whether a carry-out bit is generated as determined from a value of respective bit-positions of each of the three operands; generating a composite propagation vector and a composite generation vector from parallel prefix actions on the initial propagation vector and the initial generation vector; and calculating the sum from the initial propagation vector, the composite propagation vector and the composite generation vector.

An adder for calculating a sum of three input operands, comprising: a pre-processor, configured to create: an initial propagation vector having a plurality of bit-positions, each bit-position in the plurality representing whether a carry-in bit is propagated as a carry-out bit as determined from a value of respective bit-positions of each of the three operands; and an initial generation vector having a plurality of bit-positions, each bit-position in the plurality representing whether a carry-out bit is generated as determined from a value of respective bit-positions of each of the three operands; a generator, configured to generate a composite propagation vector and a composite generation vector from parallel prefix operations on the initial propagation vector and initial generation vector; and a post-processor, configured to calculate corresponding sum bits from the initial propagation vector, the composite propagation vector and composite generation vector.

An adder according to a previous clause, where each operand is a binary number of no more than N-bits and the sum is a binary number of not more than N+2 bits.

An adder according a previous clause, wherein the initial propagation vector, the initial generation vector, the composite propagation vector and the composite generation vector are a maximum of N-bits in length.

An adder according to a previous clause, wherein the pre-processor comprises a pre-processing block configured to create a least significant bit-position (0) of the sum.

An adder according to a previous clause, wherein the pre-processing block is configured to create the least significant bit-position (0) of the sum by performing a first logic operation on outputs of: a second logic operation on a least significant bit-position (0) of each of the operands; and three third logic operations on a least significant bit-position (0) of a first one of the operands and inverses of a least significant bit-position (0) of remaining ones of the operands, each third logic operation having a different one of the operands as the first one of the operands.

An adder according to a previous clause, wherein the pre-processor comprises a pre-processing block configured to create a corresponding bit-position of the initial propagation vector and of the initial generation vector for a bit-position other than the least significant bit-position (0) and a most significant bit-position (N−1).

An adder according to a previous clause, wherein the pre-processing block configured to create a least significant bit-position (0) of the initial propagation vector and of the initial generation vector calculates a bit-position (1) of the sum that is immediately more significant than the least significant bit-position (0) of the sum as the least significant bit-position of the initial propagation vector.

An adder according to a previous clause, wherein the sum bits calculated by the post-processor comprise bit-positions more significant than bit-positions (0) and (1) of the sum.

An adder according to a previous clause wherein the pre-processing block is configured to create a corresponding bit-position (i) of the initial propagation vector by performing a first logic operation on outputs of: a second logic operation on a carry bit and inverses of a first intermediate value and of a second intermediate value; a third logic operation on an inverse of the carry bit and the first intermediate value; and a fourth logic operation on the inverse of the carry bit and the second intermediate value.

An adder according to a previous clause, wherein the pre-processing block is configured to create a corresponding bit-position (i) of the initial generation vector by performing a fifth logic operation on outputs of: a sixth logic operation on the carry bit and the first intermediate value; and a seventh logic operation on the carry bit and the second intermediate value.

An adder according to a previous clause, wherein the pre-processing block is configured to create the carry bit by performing an eighth logic operation on outputs of each of three pair-wise ninth logic operations on a corresponding bit-position (i) of a first one and a second one of the operands, each ninth logic operation having a different first one of the operands and a different second one of the operands.

An adder according to a previous clause, wherein the pre-processing block is configured to create the first intermediate value by performing an eighth logic operation on outputs of each of three ninth logic operations on a corresponding bit-position (i+1) of a first one of the operands and inverses of a corresponding bit-position (i+1) of remaining ones of the operands, each ninth logic operation having a different one of the operands as the first one of the operands.

An adder according to a previous clause, wherein the pre-processing block is configured to create the second intermediate value by performing an eighth logic operation on a corresponding bit-position (i+1) of each of the operands.

An adder according to a previous clause, wherein the pre-processor comprises a pre-processing block configured to create a most significant bit-position (N−1) of the initial propagation vector.

An adder according to a previous clause, wherein the pre-processing block is configured to create the most significant bit-position (N−1) of the initial propagation vector by performing a first logic operation on outputs of each of three second logic operations on a corresponding most significant bit-position of a first one and a second one of the operands, each second logic operation having a different first one of the operands and a second one of the operands that is different from the first one of the operands used in such second logic operation and that is different from the second one of the operands used in each other second logic operation.

An adder according to a previous clause, wherein the pre-processing block sets a most significant bit-position (N−1) of the initial generation vector to 0.

An adder according to a previous clause, wherein the post-processor comprises a post-processing block configured to calculate a most significant bit-position (N+1) of the sum.

An adder according to a previous clause, wherein the post-processing block is configured to calculate the most significant bit-position (N+1) of the sum by performing a first logic operation on a most significant bit-position (N−1) of the composite generation vector and an output of a second logic operation on a most significant bit-position (N−1) of the composite propagation vector and a bit-position (N−k−1) of the composite generation vector.

An adder according to a previous clause, wherein the post-processor comprises a post-processing block configured to calculate a corresponding bit-position of the sum other than the most significant bit-position (N+1), a least significant bit-position (0) and a bit-position (1) of the sum that is immediately more significant than the least significant bit-position (0) of the sum.

An adder according to a previous clause, wherein the post-processing block corresponding to a bit-position (i) of the sum is configured to calculate the bit-position (i) of the sum from a first logic operation on outputs of: a second logic operation on the bit-position (i) of the initial propagation vector, an inverse of a bit-position (i−1) of the composite propagation vector and an inverse of a bit-position (i−1) of the composite generation vector; a third logic operation on the bit-position (i) of the initial propagation vector, the inverse of the bit-position (i−1) of the composite generation vector and an inverse of a bit-position (i−k−1) of the composite generation vector; a fourth logic operation on an inverse of the bit-position (i) of the initial propagation vector and the bit-position (i−1) of the composite generation vector; and a fifth logic operation on the inverse of the bit-position (i) of the initial propagation vector, the bit-position (i−1) of the composite propagation vector and the bit-position (i−k−1) of the composite generation vector.

A method for calculating a sum of three input operands, comprising actions of: creating an initial propagation vector having a plurality of bit-positions, each bit-position in the plurality representing whether a carry-in bit is propagated as a carry-out bit as determined from a value of respective bit-positions of each of the three operands; creating an initial generation vector having a plurality of bit-positions, each bit-position in the plurality representing whether a carry-out bit is generated as determined from a value of respective bit-positions of each of the three operands; generating a composite propagation vector and a composite generation vector from parallel prefix actions on the initial propagation vector and the initial generation vector; and calculating the sum from the initial propagation vector, the composite propagation vector and the composite generation vector.

All statements herein reciting principles, aspects and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated that block diagrams reproduced herein can represent conceptual views of illustrative components embodying the principles of the technology.

The purpose of the Abstract is to enable the relevant patent office or the public generally, and specifically, persons of ordinary skill in the art who are not familiar with patent or legal terms or phraseology, to quickly determine from a cursory inspection, the nature of the technical disclosure. The Abstract is neither intended to define the scope of this disclosure, which is measured by its claims, nor is it intended to be limiting as to the scope of this disclosure in any way.

While example embodiments are disclosed, this is not intended to be limiting. Rather, the general principles set forth herein are considered to be merely illustrative of the scope of the present disclosure.

It will be apparent that various modifications and variations covering alternatives, modifications and equivalents may be made to the embodiments disclosed herein, without departing from the spirit and scope of the present disclosure, as defined by the appended claims.

For example, the various elements or components may be combined or integrated in another system or certain features may be omitted, or not implemented. Also, techniques, systems, subsystems and methods described and illustrated in the various embodiments as discrete or separate may be combined or integrated with other systems, modules, techniques, or methods without departing from the scope of the present disclosure. Other examples of changes, substitutions, and alterations are easily ascertainable and could be made without departing from the spirit and scope disclosed herein.

In particular, features from one or more of the above-described embodiments may be selected to create alternative embodiments comprised of a sub-combination of features that may not be explicitly described above. In addition, features from one or more of the above-described embodiments may be selected and combined to create alternative embodiments comprised of a combination of features that may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

Other embodiments consistent with the present disclosure will be apparent from consideration of the specification and the practice of the disclosure disclosed therein. Accordingly the specification and the embodiments disclosed therein are to be considered examples only, with a true scope and spirit of the disclosure being disclosed by the following numbered claims:

What is claimed is:

1. An adder for calculating a sum of three input operands, comprising:
a pre-processor, for creating:
an initial propagation vector having a plurality of bits, each bit in the plurality representing whether a carry-in bit is propagated as a carry-out bit as determined from a value of respective bits of each of the three operands; and
an initial generation vector having a plurality of bits, each bit in the plurality representing whether a carry-out bit is generated as determined from a value of respective bits of each of the three operands;
a generator, for generating a composite propagation vector and a composite generation vector from parallel prefix operations on the initial propagation vector and initial generation vector; and
a post-processor, for calculating corresponding sum bits from the initial propagation vector, the composite propagation vector and composite generation vector.

2. An adder according to claim 1, wherein the pre-processor comprises a pre-processing block configured to output a least significant bit s₀ of the sum.

3. An adder according to claim 2, wherein the pre-processing block is configured to determine the least significant bit by performing logical operations that have logical equivalence with the equation:
s₀=(x₀′*y₀′)′,
where x₀ is an intermediate value that has logical equivalence with:
x₀=a₀*b₀′*c₀′+a₀′*b₀*c₀′+a₀′*b₀′*c₀,
where y₀ is an intermediate value that has logical equivalence with:
y₀=a₀*b₀*c₀, and
where a₀, b₀ and c₀ are the least significant bits of the operands.

4. An adder according to claim 1, wherein the pre-processor comprises a pre-processing block configured to create a corresponding i^{th} bit p_{0,i} of the initial propagation other than a most significant bit thereof, by performing logical operations that have logical equivalence with the equation:
p_{0,i}=xᵢ₊₁′*yᵢ₊₁′*rᵢ+xᵢ₊₁*rᵢ′+yᵢ₊₁*rᵢ′,
where xᵢ₊₁ is an intermediate value that has logical equivalence with:
xᵢ₊₁=aᵢ₊₁*bᵢ₊₁′*cᵢ₊₁′+aᵢ₊₁′*bᵢ₊₁*cᵢ₊₁′+aᵢ₊₁′*bᵢ₊₁′*cᵢ₊₁,
where yᵢ₊₁ is an intermediate value that has logical equivalence with:
yᵢ₊₁=aᵢ₊₁*bᵢ₊₁*cᵢ₊₁,
where rᵢ is a carry bit that has logical equivalence with:
rᵢ=aᵢ*bᵢ+aᵢ*cᵢ+bᵢ*cᵢ, and
where aᵢ, bᵢ and cᵢ are the i^{th} and aᵢ₊₁, bᵢ₊₁ and cᵢ₊₁ are the i+1^{st} bits of the operands.

5. An adder according to claim 4, wherein the pre-processing block is configured to create a corresponding i^{th} bit g_{0,i} of the initial generation vector other than a most significant bit thereof, by performing logical operations that have logical equivalence with the equation:
g_{0,i}=xᵢ₊₁*rᵢ+yᵢ₊₁*rᵢ.

6. An adder according claim 4, wherein the pre-processor comprises a plurality of pre-processing blocks, respectively corresponding to each bit of the initial propagation vector other than the most significant bit thereof.

7. An adder according to claim 6, wherein the pre-processing block corresponding to the least significant bit of the initial propagation vector is configured to output a 1^{st} bit of the sum that is equal to the least significant bit, p_{0,0}, of the initial propagation vector.

8. An adder according to claim 7, wherein the sum bits calculated by the post-processor reflect bits more significant than the 0^{th} and 1^{st} bits of the sum.

9. An adder according to claim 1, wherein the pre-processor comprises a pre-processing block configured to create a most significant N−1^{st} bit p_{0,N-1} of the initial propagation vector by performing logical operations that have logical equivalence with the equation:
p_{0,N-1}=a_{N-1}*b_{N-1}+a_{N-1}*c_{N-1}+b_{N-1}*c_{N-1},
where a_{N-1}, b_{N-1} and c_{N-1}, are the N−1^{st} bits of the operands.

10. An adder according to claim 10, wherein the pre-processing block sets a most significant N−1^{st} bit of the initial generation vector to 0.

11. An adder according to claim 1, wherein the post-processor comprises a post-processing block configured to calculate a most significant N+1^{st} bit s_{N+1} of the sum by performing logical operations that have logical equivalence with the equation:
s_{N+1}=g_{log 2(N),N-1}+p_{log 2(N)-1,N-1}*g_{log 2(N)-1,N-k-1},
where p_{log 2(N)-1,N-1} is the most significant bit of the composite propagation vector,
where g_{log 2(N)-1,N-1} is the most significant bit of the composite generation vector, and
where g_{log 2(N)-1,N-k-1} is the N−k−1^{st} bit of the composite generation vector.

12. An adder according to claim 1, wherein the post-processor comprises a post-processing block configured to calculate a corresponding bit of the sum sᵢ other than the most significant bit, a least significant bit and a 1^{st} bit of the sum by performing logical operations, that have logical equivalence with the equation:
sᵢ=p_{0,i} ⊕ (p_{log 2(N)-1,i-1}*g_{log 2(N)-1,i-1}+g_{log 2(N)-1,i-k-1}),
where p_{0,i} is an i^{th} bit-position of the initial propagation vector,
where p_{log 2(N)-1,i-1} is an i−1^{st} bit-position of the composite propagation vector,
where g_{log 2(N)-1,i-1} is an i−1^{st} bit-position of the composite generation vector, and
where g_{log 2(N)-1,i-k-1} is an i−k−1^{st} bit-position of the composite generation vector.

13. A method for calculating a sum of three input operands, comprising actions of:
creating an initial propagation vector having a plurality of bits, each bit in the plurality representing whether a carry-in bit is propagated as a carry-out bit as determined from a value of respective bits of each of the three operands;
creating an initial generation vector having a plurality of bits, each bit in the plurality representing whether a carry-out bit is generated as determined from a value of respective bits of each of the three operands;
generating a composite propagation vector and a composite generation vector from parallel prefix actions on the initial propagation vector and the initial generation vector; and
calculating the sum from the initial propagation vector, the composite propagation vector and the composite generation vector.

14. A method according to claim 13, wherein the action of creating an initial propagation vector comprises outputting a least significant bit s₀ of the sum.

15. A method according to claim 14, wherein the action of outputting comprises performing logical operations that have logical equivalence with the equation:
s₀=(x₀′*y₀′)′,
where x₀ is an intermediate value that has logical equivalence with:
x₀=a₀*b₀′*c₀′+a₀′*b₀*c₀′+a₀′*b₀′*c₀,
where y₀ is an intermediate value that has logical equivalence with:
y₀=a₀*b₀*c₀, and
where a₀, b₀ and c₀ are the least significant bits of the operands.

16. A method according to claim 13, wherein the action of creating an initial propagation vector comprises generating a corresponding i^{th} bit p_{0,i} of the initial propagation other than a most significant bit thereof, by performing logical operations that have logical equivalence with the equation:
p_{0,i}=xᵢ₊₁′*yᵢ₊₁′*rᵢ+xᵢ₊₁*rᵢ′+yᵢ₊₁*rᵢ′,
where xᵢ₊₁ is an intermediate value that has logical equivalence with:
xᵢ₊₁=aᵢ₊₁*bᵢ₊₁′*cᵢ₊₁′+aᵢ₊₁′*bᵢ₊₁*cᵢ₊₁′+aᵢ₊₁′*bᵢ₊₁′*cᵢ₊₁,
where yᵢ₊₁ is an intermediate value that has logical equivalence with:
yᵢ₊₁=aᵢ₊₁*bᵢ₊₁*cᵢ₊₁,
where rᵢ is a carry bit that has logical equivalence with:
rᵢ=aᵢ*bᵢ+aᵢ*cᵢ+bᵢ*cᵢ, and
where aᵢ, bᵢ and cᵢ are the i^{th} and aᵢ₊₁, bᵢ₊₁ and cᵢ₊₁ are the i+1^{st} bits of the operands.

17. A method according to claim 16, wherein the action of creating an initial generation vector comprises generating a corresponding i^{th} bit g_{0,i} of the initial generation vector other than a most significant bit thereof, by performing logical operations that have logical equivalence with the equation:
g_{0,i}=xᵢ₊₁*rᵢ+yᵢ₊₁*rᵢ.

18. A method according to claim 6, wherein the action of generating a corresponding i^{th} bit p_{0,i} comprises outputting a 1^{st} bit of the sum that is equal to the least significant bit, p_{0,0}, of the initial propagation vector.

19. A method according to claim 18, wherein the action of calculating the sum comprises calculating sum bits more significant than the 0^{th} and 1^{st} bits of the sum.

20. A method according to claim 13, wherein the action of creating an initial propagation vector comprises generating a most significant N−1^{st} bit p_{0,N-1} of the initial propagation vector by performing logical operations that have logical equivalence with the equation:
p_{0,N-1}=a_{N-1}*b_{N-1}+a_{N-1}*c_{N-1}+b_{N-1}*c_{N-1},
where a_{N-1}, b_{N-1} and c_{N-1}, are the N−1^{st} bits of the operands.

21. A method according to claim 13, wherein the action of creating an initial generation vector comprises setting a most significant N−1^{st} bit of the initial generation vector to 0.

22. A method according to claim 13, wherein the action of calculating the sum comprises calculating a most significant N+1^{st} bit s_{N+1} of the sum by performing logical operations that have logical equivalence with the equation:
s_{N+1}=g_{log 2(N),N-1}+p_{log 2(N)-1,N-1}*g_{log 2(N)-1,N-k-1},
where p_{log 2(N)-1,N-1} is the most significant bit of the composite propagation vector,
where g_{log 2(N)-1,N-1} is the most significant bit of the composite generation vector, and
where g_{log 2(N)-1,N-k-1} is the N−k−1^{st} bit of the composite generation vector.

23. A method according to claim 13, wherein the action of calculating the sum comprises calculating a corresponding bit of the sum sᵢ other than the most significant bit, a least significant bit and a 1^{st} bit of the sum by performing logical operations, that have logical equivalence with the equation:
sᵢ=p_{0,i} ⊕ (p_{log 2(N)-1,i-1}*g_{log 2(N)-1,i-1}+g_{log 2(N)-1,i-k-1}),
where p_{0,i} is an i^{th} bit-position of the initial propagation vector,
where p_{log 2(N)-1,i-1} is an i−1^{st} bit-position of the composite propagation vector,
where g_{log 2(N)-1,i-1} is an i−1^{st} bit-position of the composite generation vector, and
where g_{log 2(N)-1,i-k-1} is an i−k−1^{st} bit-position of the composite generation vector.
